(19) United States
(12) Patent Application Publication
(10) Pub. No.: US 2025/0287242 A1
(43) Pub. Date: Sep. 11, 2025

(54) First Network Node, Second Network Node, Wireless Device, and Methods Performed Thereby for Handling One or More Reports

(71) Applicant: Telefonaktiebolaget LM Ericsson (publ), Stockholm (SE)

(72) Inventors: Pablo Soldati, Solna (SE); Luca Lunardi, Genova (IT)

(21) Appl. No.: 18/851,445

(22) PCT Filed: Mar. 30, 2023
(86) PCT No.: PCT/SE2023/050288

§ 371 Date: Sep. 26, 2024

Related U.S. Application Data
(60) Provisional application No. 63/362,201, filed on Mar. 31, 2022.

(51) Int. Cl. H04W 24/10; H04W 24/02

(52) U.S. Cl. CPC H04W 24/10; H04W 24/02

(57) ABSTRACT

A method performed by a first network node (111). The method is for handling one or more reports. The first network node (111) operates in a wireless communications network (100). The first network node (111) receives (604) a message, from at least one of a second network node (112) and one or more wireless devices (130) operating in the wireless communications network (100). The message comprises one or more reports comprising respective information of a respective Life-Cycle Management (LCM), of one or more machine learning (ML) models. The one or more ML models are available at least in part in at least one of the one or more wireless devices (130). The first network node (111) then performs (606) one or more actions using the information comprised in at least one of the one or more reports.

### TECHNICAL FIELD

The present disclosure relates generally to a first network node and methods performed thereby for handling one or more reports. The present disclosure further relates generally to a second network node and methods performed thereby, for handling the one or more reports. The present disclosure further relates generally to a wireless device and methods performed thereby, for handling the one or more reports.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC or 5G CN.

The current 5G RAN (NG-RAN) architecture is depicted and described in TS 38.401 v. 15.8.0, FIG. 6.1-1, which is reproduced herein as FIG. 1.

The NG-RAN may comprise a set of Radio base stations in NR (gNBs) connected to the 5G Core network (5GC) through the NG interface.

As specified in TS 38.300, NG-RAN may also comprise a set of ng-eNBs. An ng-eNB may comprise an ng-eNB-Central Unit (CU) and one or more ng-eNB-Distributed Units (DUs). An ng-eNB-CU and an ng-eNB-DU may be connected via W1 interface. The general principle described in this section may be understood to also apply to ng-eNB and W1 interface, if not explicitly specified otherwise.

An gNB may support Frequency Division Duplex (FDD) mode, Time Division Duplex (TDD) mode or dual mode operation.

gNBs may be interconnected through the Xn interface.

A gNB may comprise a gNB-CU and one or more gNB-DU(s). A gNB-CU and a gNB-DU may be connected via F1 interface.

One gNB-DU may be connected to only one gNB-CU. NG, Xn and F1 may be understood to be logical interfaces.

For NG-RAN, the NG and Xn-C interfaces for a gNB comprising a gNB-CU and gNB-DUs, may terminate in the gNB-CU. For EN-DC, the S1-U and X2-C interfaces for a gNB consisting of a gNB-CU and gNB-DUs, may terminate in the gNB-CU. The gNB-CU and connected gNB-DUs may only be visible to other gNBs and the 5GC as a gNB.

The overall architecture for separation of gNB-CU-CP and gNB-CU-UP is depicted in FIG. 2, corresponding to FIG. 6.1.2-1. of TS 38.401 v. 15.8.0.

### Existing Methods and Ongoing 3GPP Discussion

A 3GPP Technical Report (TR) 37.817 has been produced as an outcome of the Study Item (SI) “Enhancement for Data Collection for NR and EN-DC” defined in 3GPP RP-201620.

The study item aimed to study the functional framework for RAN intelligence enabled by further enhancement of data collection through use cases, examples etc. and identify the potential standardization impacts on current NG-RAN nodes and interfaces.

According to TR 37.817, the following high-level principles may be required to be applied for Artificial Intelligence (AI)-enabled RAN intelligence.

The detailed AI/Machine-Learning (ML) algorithms and models for use cases may be implementation specific and out of RAN3 scope.

The study may be understood to focus on AI/ML functionality and corresponding types of inputs/outputs.

The input/output and the location of the Model Training and Model Inference function may be required to be studied case by case.

The study may be understood to focus on the analysis of data that may be needed at the Model Training function from Data Collection, while the aspects of how the Model Training function uses inputs to train a model may be understood to be out of RAN3 scope.

The study may be understood to focus on the analysis of data that may be needed at the Model Inference function from Data Collection, while the aspects of how the Model Inference function uses inputs to derive outputs may be understood to be out of RAN3 scope.

Where AI/ML functionality resides within the current RAN architecture, may depend on deployment and on the specific use cases.

The Model Training and Model Inference functions may be required to be able to request, if needed, specific information to be used to train or execute the AI/ML algorithm and to avoid reception of unnecessary information. The nature of such information may depend on the use case and on the AI/ML algorithm.

The Model Inference function may be required to signal the outputs of the model only to nodes that may have explicitly requested them, e.g., via subscription, or nodes that may take actions based on the output from Model Inference.

An AI/ML model used in a Model Inference function may have to be initially trained, validated and tested by the Model Training function before deployment.

NG-RAN SA may be prioritized; Evolved Universal Terrestrial Radio Access Network (E-UTRAN)-NR Dual Connectivity (EN-DC) and Multi Radio-Dual Connectivity (MR-DC) may be down-prioritized, but not precluded from Rel. 18.

Functional framework and high-level procedures defined in this TR may be required to not prevent from “thinking beyond” them during normative phase if a use case may require so.

User data privacy and anonymisation may be required to be respected during AI/ML operation.

The Functional Framework for RAN Intelligence is shown in FIG. 4.2-1 of the same TR, which is reproduced herein as FIG. 3, reported below.

Data Collection may be understood to be a function that may provide input data to Model training and Model inference functions. AI/ML algorithm specific data preparation, e.g., data pre-processing and cleaning, formatting, and transformation, may be not carried out in the Data Collection function.

Examples of input data may include measurements from UEs or different network entities, feedback from Actor, output from an AI/ML model. Training Data may be understood as data that may be needed as input for the AI/ML Model Training function. Inference Data may be understood as data that may be needed as input for the AI/ML Model Inference function.

Model Training may be understood as a function that may perform the AI/ML model training, validation, and testing which may generate model performance metrics as part of the model testing procedure. The Model Training function may be understood to be also responsible for data preparation, e.g., data pre-processing and cleaning, formatting, and transformation, based on Training Data delivered by a Data Collection function, if required. Model Deployment/Update may be used to initially deploy a trained, validated, and tested AI/ML model to the Model Inference function or to deliver an updated model to the Model Inference function. It was noted that details of the Model Deployment/Update process as well as the use case specific AI/ML models transferred via this process are out of RAN3 Rel-17 study scope. The feasibility to single-vendor or multi-vendor environment has not been studied in RAN3 Rel-17 study.

Model Inference may be required to be a function that may provide AI/ML model inference output, e.g., predictions or decisions. Model Inference function may provide Model Performance Feedback to Model Training function when applicable. The Model Inference function may be also responsible for data preparation, e.g., data pre-processing and cleaning, formatting, and transformation, based on Inference Data delivered by a Data Collection function, if required. The output may be may be the inference output of the AI/ML model produced by a Model Inference function. It was noted that details of inference output may be use case specific. Model Performance Feedback may be used for monitoring the performance of the AI/ML model, when available. It was noted that details of the Model Performance Feedback process may be understood to be out of RAN3 scope. Actor may be understood to be a function that may receive the output from the Model Inference function and may trigger or perform corresponding actions. The Actor may trigger actions directed to other entities or to itself. Feedback may be understood as information that may be needed to derive training data, inference data or to monitor the performance of the AI/ML Model and its impact to the network through updating of KPIs and performance counters.

At the RAN3#114-e meeting, contribution R3-215244 has proposed to introduce a model management function in the Functional Framework for RAN Intelligence, as reported below.

According to this proposition, model deployment/update may be required to be decided by model management instead of model training. The model management may also host a model repository. The model deployment/update may be required to be performed by model management.

Model performance monitoring may be understood to be a key function to assist and control model inference. The model performance feedback from model inference may be required to be first sent to model management. If the performance is not ideal, the model management may decide to fallback to traditional algorithm or change/update the model.

The model training may be required to be also controlled by model management.

The model management function may be taken by either Operation and Maintenance (OAM) or CU or other network entities depending on the use cases. Clearly defining a model management function may be useful for future signalling design and analysis.

A first proposal was to introduce a model management function into AI/ML framework as shown in FIG. 4. The Model management function may support the following roles: requesting model training and receiving the model training result, model deployment/updates for inference, model performance monitoring, including receiving performance feedback from model inference and taking necessary action, e.g., keep the model, fallback to traditional algorithm, change or update the model, etc., Model storage and Model compiling (optional).

In RP-213599, Study on Artificial Intelligence (AI)/Machine Learning (ML) for NR Air Interface, the following use cases were selected where certain collaboration level may be required to be supported between gNB and UEs, particularly: a) CSI feedback enhancement, e.g., overhead reduction, improved accuracy, prediction, b) Beam management, e.g., beam prediction in time, and/or spatial domain for overhead and latency reduction, beam selection accuracy improvement and c) Positioning accuracy enhancements for different scenarios including, e.g., those with heavy Non Line of Sight (NLOS) conditions. Existing AI/ML methods may result, under certain circumstances, in wasted resources and hinder the performance of a communications network.

### SUMMARY

As part of the development of embodiments herein, one or more challenges with the existing technology will first be identified and discussed.

Life cycle management (LCM) of AI/ML models in radio access networks (RANs) may be understood to be particularly difficult due to the distributed nature of the RAN itself. A RAN may host multiple training functions in different network nodes, as well a multiple inference functions in network nodes and/or at the user devices.

The possibility of user devices to move in the network, while being required to execute inference of AI/ML models, poses additional problems for efficiently performing LCM operation of the AI/ML models of the user device and make available information related to the LCM state of the AI/ML model of the user devices across other network entities.

In particular, the AI/ML model of a user device may require undergoing certain LCM operations at any point in time while being connected to a certain cell, where the required LCM operations for the AI/ML model, may be performed by the serving node and/or the user device itself. Additionally, certain LCM may be provided by the serving node, such as AI/ML model modifying, re-train, update, while other operations may be performed by the user device, such as AI/ML model testing, validating, evaluating. More importantly, the result of the LCM operations performed for a certain AI/ML model of a user device may be known only locally at the serving node and/or the user device itself.

However, as the user device moves from the coverage area of a serving cell/node to the coverage area of a target cell/node, other network entities, such as target cell/node, may be required to know whether the AI/ML models of the user device have undergone any LCM operations, as well as the what LCM operations may have been performed for the AI/ML model, e.g., whether the AI/ML model may have been updated, re-trained, modified, tested, validated, verified, evaluated, etc., the results of such LCM operations, e.g., whether the AI/ML model fulfils certain testing or validation criteria, and which entity may have performed LCM operations, e.g., what LCM operations may have been performed by which network node and by what LCM operations have been performed by the user device.

Existing or published technology, such as the AI/ML Functional Frameworks defined by different standardization bodies, such as 3GPP and ORAN, do not provide a solution to this problem, but rather limit themselves to describing the interaction between a user device and the RAN in terms of UE measurements that may be used as input for a training function.

It is therefore an object of embodiments herein to improve the handling of handling one or more reports in a wireless communications network.

According to a first aspect of embodiments herein, the object is achieved by a method, performed by a first network node. The method is for handling one or more reports. The first network node operates in a wireless communications network. The first network node receives a message, from at least one of a second network node and one or more wireless devices operating in the wireless communications network. The message comprises one or more reports comprising respective information of a respective Life-Cycle Management (LCM) of one or more machine learning (ML) models. The one or more ML models are available at least in part in at least one of the one or more wireless devices. The first network node then performs one or more actions using the information comprised in at least one of the one or more reports.

According to a second aspect of embodiments herein, the object is achieved by a method, performed by the second network node. The method is for handling the one or more reports. The second network node operates in the wireless communications network. The second network node sends the message, to the first network node operating in the wireless communications network. The message comprises the one or more reports comprising the respective information, of the respective LCM, of the one or more ML models. The one or more ML models are available at least in part in at least one of one or more wireless devices operating in the wireless communications network.

According to a third aspect of embodiments herein, the object is achieved by a method, performed by the wireless device. The method is for handling the one or more reports. The wireless device operates in the wireless communications network. The wireless device receives a third message from the second network node operating in the wireless communications network. The third message comprises a request to receive the one or more reports comprising the respective information, of the respective LCM of one or more ML models. The one or more ML models are available at least in part in the wireless device. The wireless device then sends an additional message, to one of the second network node and the first network node operating in the wireless communications network. The additional message comprises the one or more reports comprising the respective information.

According to a fourth aspect of embodiments herein, the object is achieved by the first network node. The first network node may be understood to be for handling the one or more reports. The first network node is configured to operate in the wireless communications network. The first network node is configured to receive the message, from at least the one of the second network node and the one or more wireless devices configured to operate in the wireless communications network. The message is configured to comprise the one or more reports configured to comprise the respective information of the respective LCM of the one or more ML models. The one or more ML models are configured to be available at least in part in the at least one of the one or more wireless devices. The first network node is also configured to perform the one or more actions using the information configured to be comprised in at least one of the one or more reports.

According to a fifth aspect of embodiments herein, the object is achieved by the second network node. The network node may be understood to be for handling the one or more reports. The second network node is configured to operate in the wireless communications network. The second network node is further configured to send the message, to the first network node configured to operate in the wireless communications network. The message is configured to comprise the one or more reports configured to comprise the respective information, of the respective LCM, of the one or more ML models. The one or more ML models are configured to be available at least in part in at least one of one or more wireless devices configured to operate in the wireless communications network.

According to a sixth aspect of embodiments herein, the object is achieved by the wireless device. The wireless device may be understood to be for handling the one or more reports. The wireless device is configured to operate in the wireless communications network. The wireless device is configured to receive the third message from the second network node configured to operate in the wireless communications network. The third message is configured to comprise the request to receive the one or more reports configured to comprise the respective information, of the respective LCM, of the one or more ML models. The one or more ML models are configured to be available at least in part in the wireless device. The wireless device is further configured to send the additional message, to one of the second network node and the first network node configured to operate in the wireless communications network. The additional message is configured to comprise the one or more reports configured to comprise the respective information.

Non limiting examples of advantages of enabling the first network node and the second network node to exchange life cycle management information reports concerning AI/ML models deployed, or to be deployed, at the one or more wireless devices may be in scenarios such as follows. A scenario may be that the first inference function of the (first) AI/ML model deployed in the wireless device may operate jointly with a second inference function of a second AI/ML model residing in a network node, such as a first network node, or the second network node. A second scenario may be that the inference function of the (first) AI/ML model deployed in the wireless device may operate jointly with a different function, e.g., a training function, of the same AI/ML model residing in a network node, such as the first network node, or the second network node. A third scenario may be that a new, or updated, AI/ML model may be pushed over the air for wireless devices based on certain characteristics, e.g., wireless devices exposing certain radio capabilities, wireless devices using certain applications, wireless devices with certain version of the Operating System.

One particular case wherein it may be understood to be advantageous to enable a network node to exchange life cycle management information reports of test activities concerning AI/ML models deployed, or to be deployed, at the one or more wireless devices may be the case of user mobility. When the wireless device may move from the coverage area of a network node such as the second network node to the coverage area of another network node such as the first network node, it may be understood to be beneficial for the network node that may receive the wireless device to know whether the AI/ML models deployed at the wireless device may have undergone any LCM operations, as well as the/what LCM operations may have been performed for the AI/ML model, e.g., whether the AI/ML model may have been updated, re-trained, modified, tested, validated, verified, evaluated, secured, etc., the results of such LCM operations, e.g., whether the A/IML model may fulfil certain testing or validation criteria, and which entity may have performed LCM operations, e.g., what LCM operations may have been performed by which network node and what LCM operations may have been performed by the wireless device. This information may ensure to enable the first network node receiving the wireless device to serve the wireless device in the best way, thereby improving the system performance and the quality of experience of the wireless device.

### BRIEF DESCRIPTION OF THE DRAWINGS

Examples of embodiments herein are described in more detail with reference to the accompanying drawings, and according to the following description.

FIG. 1 is a schematic representation depicting an example of the overall architecture of an NG-RAN, according to existing methods.

FIG. 2 is a schematic representation depicting an example of the overall architecture for the separation of gNB-CU-CP and gNB-CU-UP, according to existing methods.

FIG. 3 is a schematic representation depicting an example of the Functional Framework for RAN Intelligence, according to existing methods.

FIG. 4 is a schematic representation depicting an example of an AI/ML framework with model management, according to existing methods.

FIG. 5 is a schematic diagram illustrating a wireless communications network, according to embodiments herein.

FIG. 6 is a flowchart depicting an example of a method performed by a first network node, according to embodiments herein.

FIG. 7 is a flowchart depicting an example of a method performed by a second network node, according to embodiments herein.

FIG. 8 is a flowchart depicting an example of a method performed by a wireless device, according to embodiments herein.

FIG. 9 is a schematic representation depicting a non-limiting example of a method performed in a wireless communications network, according to embodiments herein.

FIG. 10 is a schematic representation depicting another non-limiting example of a method performed in a wireless communications network, according to embodiments herein.

FIG. 11 is a schematic representation depicting a further non-limiting example of a method performed in a wireless communications network, according to embodiments herein.

FIG. 12 is a schematic representation depicting an additional non-limiting example of a method performed in a wireless communications network, according to embodiments herein.

FIG. 13 is a schematic representation depicting yet another non-limiting example of a method performed in a wireless communications network, according to embodiments herein.

FIG. 14 is a schematic representation depicting a further non-limiting example of a method.

FIG. 15 is a schematic block diagram illustrating two non-limiting examples, a) and b), of a first network node, according to embodiments herein.

FIG. 16 is a schematic block diagram illustrating two non-limiting examples, a) and b), of a second network node, according to embodiments herein.

FIG. 17 is a schematic block diagram illustrating two non-limiting examples, a) and b), of a wireless device, according to embodiments herein.

FIG. 18 is a schematic block diagram illustrating a telecommunication network connected via an intermediate network to a host computer, according to embodiments herein.

FIG. 19 is a generalized block diagram of a host computer communicating via a base station with a user equipment over a partially wireless connection, according to embodiments herein.

FIG. 20 is a flowchart depicting embodiments of a method in a communications system including a host computer, a base station and a user equipment, according to embodiments herein.

FIG. 21 is a flowchart depicting embodiments of a method in a communications system including a host computer, a base station and a user equipment, according to embodiments herein.

FIG. 22 is a flowchart depicting embodiments of a method in a communications system including a host computer, a base station and a user equipment, according to embodiments herein.

FIG. 23 is a flowchart depicting embodiments of a method in a communications system including a host computer, a base station and a user equipment, according to embodiments herein.

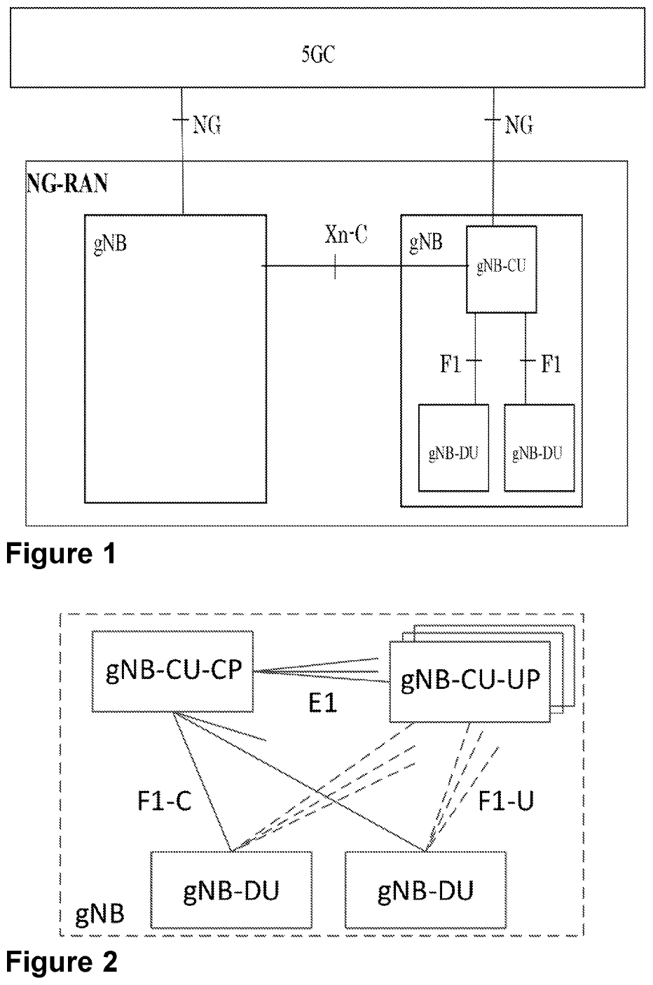

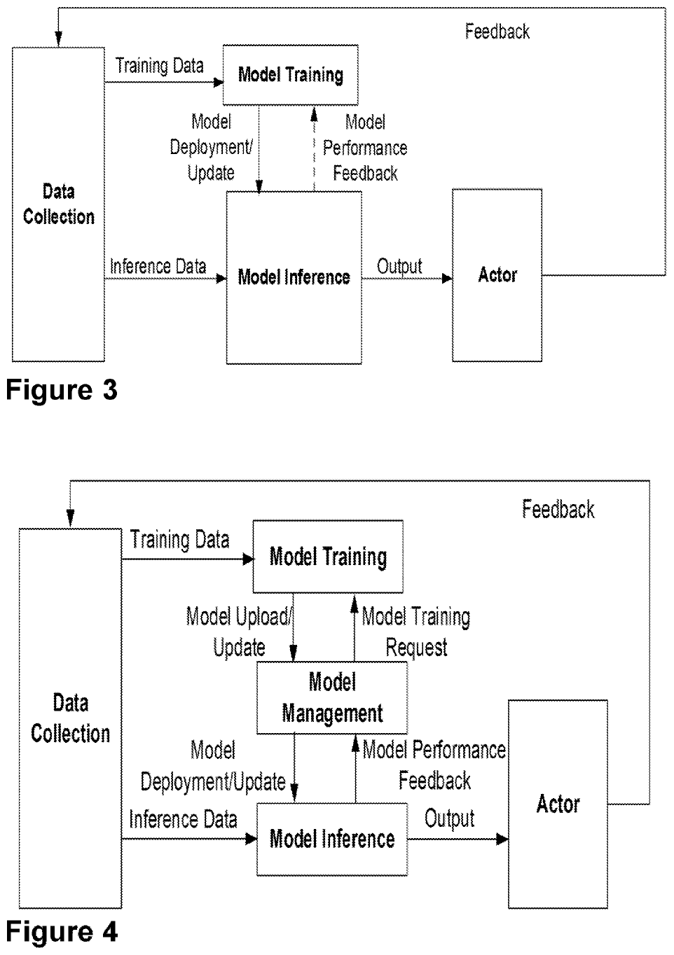

### DETAILED DESCRIPTION

Certain aspects of the present disclosure and their embodiments may provide solutions to the challenges discussed in the Summary section or other challenges. There are, proposed herein, various embodiments which address one or more of the issues disclosed herein.

Embodiments herein may be understood to be related to methods of handling reports of Lifecycle Management for UE's AI/ML models.

Embodiments herein may relate to a method for a first network node to request to or obtain, from a second network node or a UE, reports comprising life cycle management (LCM) information associated to an AIML model executed by or deployed at a user device. The LCM information requested or obtained by the first network node may comprise one or more of: information related to test activities of AI/ML model(s) deployed in a UE, information related to validation activities of AI/ML models deployed at the UE, information related to verification activities of AI/ML models deployed at the UE, information related to evaluation activities of AI/ML models deployed at the UE, information related to security assessments of AI/ML models deployed at the UE, and information related to re-training, updating or modification of AI/ML models deployed at the UE.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

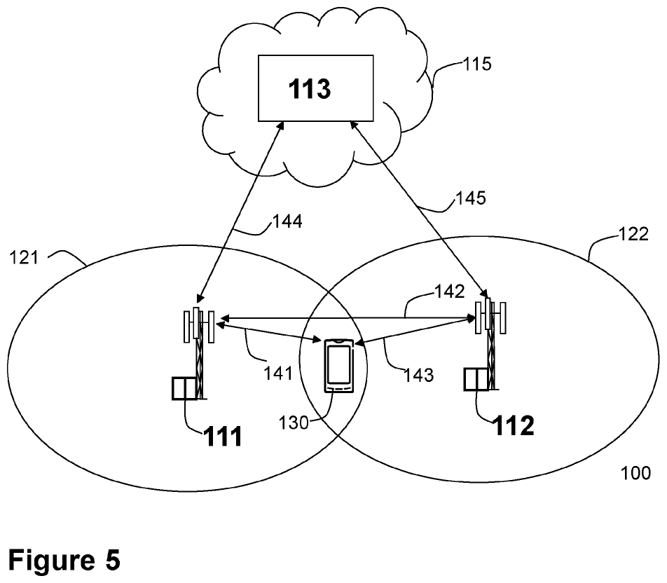

FIG. 5 depicts two non-limiting example of a wireless communications network 100, sometimes also referred to as a wireless communications system, cellular radio system, or cellular network, in which embodiments herein may be implemented. The wireless communications network 100 may typically be a 5G system, 5G network, NR-U or Next Gen System or network, Licensed-Assisted Access (LAA), MulteFire. The wireless communications network 100 may support a younger system than a 5G system. The wireless communications network 100 may support other technologies, such as, for example Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, etc . . . Other examples of other technologies the wireless communications network 100 may support may be Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), IoT, NB-IoT, or any cellular network or system. Thus, although terminology from 5G/NR and LTE may be used in this disclosure to exemplify embodiments herein, this should not be seen as limiting the scope of the embodiments herein to only the aforementioned systems.

The wireless communications network 100 comprises a first network node 111 and a second network node 112, as depicted in the non-limiting example FIG. 5. In some embodiments, the wireless communications network 100 may comprise a third network node 113, as depicted in the non-limiting example FIG. 5. Any of the first network node 111, the second network node 112 and the third network node 113 may be a radio network node or a core network node. A radio network node may be understood as a transmission point such as a radio base station, for example a gNB, an eNB, or any other network node with similar features capable of serving a wireless device, such as a user equipment or a machine type communication device, in the wireless communications network 100. In other examples, which are not depicted in FIG. 5, any of the first network node 111, the second network node 112 and the third network node 113 may be a distributed node, such as a virtual node in the cloud 115, and may perform its functions entirely on the cloud 115, or partially, in collaboration with a radio network node. In the non-limiting example depicted in FIG. 5, the third network node 113 is a network node in the cloud 115. The first network node 111, the second network node 112 and the third network node 113 may, in some examples, be co-located or be the same network node. In typical examples, such as those depicted in FIG. 5, the first network node 111 and the second network node 112 may be different nodes. Any of the second network node 112 and the third network node 113 may be a core network node in the wireless communications network 100, as depicted in FIG. 5 for the third network node 113. In other examples, such as that depicted in FIG. 5, the second network node 112 may be another radio network node in the wireless communications network 100. In such examples, the first network node 111 may be also referred to herein as a target network node. The second network node 112 may be also referred to as a source network node. Further details on the first network node 111, the second network node 112 and the third network node 113 are provided later.

The wireless communications network 100 covers a geographical area which may be divided into cell areas, wherein each cell area may be served by a network node, although, one radio network node may serve one or several cells. The wireless communications network 100 may comprise a first cell 121, which may be also referred to herein as a target cell. The first cell 121 may be served by the first network node 111. In some embodiments, the wireless communications network 100 may also comprise a second cell 122, which may be also referred to herein as a source cell. The second cell 122 may be served by the second network node 112.

Any of the first network node 111 and the second network node 112 may be of different classes, such as, e.g., macro base station, home base station or pico base station, based on transmission power and thereby also cell size. Any of the first network node 111 and the second network node 112 may support one or several communication technologies, and its name may depend on the technology and terminology used. In 5G/NR, any of the first network node 111 and the second network node 112 may be referred to as a gNB and may be directly connected to one or more core networks.

One or more wireless devices comprising at least a wireless device 130 may be comprised in the wireless communication network 100. The one or more wireless devices 130 are represented in the non-limiting example of FIG. 5 as a single wireless device 130. Any of the one or more wireless devices 130 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the one or more wireless devices 130 comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. Any of the one or more wireless devices 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The first network node 111 may be configured to communicate within the wireless communications network 100 with any of the one or more wireless devices 130 in the first cell 121 over a respective first link 141, e.g., a radio link. The first network node 111 and the second network node 112 may be configured to communicate within the wireless communications network 100 over a second link 142, e.g., a wired link, a radio link or an X2 interface. The second network node 112 may be configured to communicate within the wireless communications network 100 with any of the one or more wireless devices 130 in the second cell 122 over a respective third link 143, e.g., a radio link. The first network node 111 may be configured to communicate within the wireless communications network 100 with the third network node 113 over a fourth link 144, e.g., a radio link or a wired link. The second network node 112 may be configured to communicate within the wireless communications network 100 with the third network node 113 over a fifth link 145, e.g., a radio link.

In general, the usage of “first”, “second”, “third”, “fourth”, . . . , “twentieth”, and/or herein may be understood to be an arbitrary way to denote different elements or entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a first network node, such as the first network node 111, e.g., a gNB-Central Unit Control Plane (CU-CP), embodiments related to a second network node, such as the second network node 112, e.g., a gNB-DU and embodiments related to a wireless device, such as any of the any of the one or more wireless devices 130, e.g., a UE.

Some embodiments herein will now be further described with some non-limiting examples.

In the following description, any reference to a/the first network node may be understood to equally refer to any of the first network node 111; any reference to a/the second network node may be understood to equally refer to the second network node 112; any reference to a/the network node may be understood to equally apply to any of the first network node 111 and the second network node 112; and reference to a/the UE may be understood to equally refer to the wireless device 130.

### Terminology

A network node may be a RAN node, deployed in monolithic architecture or in split architecture, one of the function of a RAN node deployed in split architecture, a Core Network node, an OAM, a Service Management and Orchestration (SMO), a Network Management System (NMS), a Non-Real Time RAN Intelligent Controller (Non-RT RIC), a Real-Time RAN Intelligent Controller (RT-RIC), a gNB, Evolved Node B/E-UTRAN Node B (eNB), a gNB acting as a secondary node in an EN-DC scenario, that is, in a Dual Connectivity (DC) scenario with an eNB as the master node and a gNB as the secondary node (en-gNB), ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Cloud-based network function, a Cloud-based centralized training node.

The terms UE and “user device” are used interchangeably.

The methods provided in the present disclosure may be understood to be independent with respect to specific AI/ML model types or learning problems/setting, e.g., supervised learning, unsupervised learning, reinforcement learning, hybrid learning, centralized learning, federated learning, distributed learning, . . .

Non limiting examples of AI/ML algorithms may include supervised learning algorithms, deep learning algorithms, reinforcement learning type of algorithms, such as DQN, A2C, A3C, etc., contextual multi-armed bandit algorithms, autoregression algorithms, etc., or combinations thereof.

Such algorithms may exploit functional approximation models, hereafter referred to as AI/ML models, such as neural networks, e.g., feedforward neural networks, deep neural networks, recurrent neural networks, convolutional neural networks, etc.

Examples of reinforcement learning algorithms may include deep reinforcement learning, such as deep Q-network (DQN), proximal policy optimization (PPO), double Q-learning, actor-critic algorithms, such as Advantage actor-critic algorithms, e.g., A2C or A3C, actor-critic with experience replay, etc, policy gradient algorithms, off-policy learning algorithms, etc.

With respect to the methods executed by network nodes, e.g., first network node 111, second network node 112, described in embodiments herein, those may be executed in scenarios where a direct signaling connection may exist between the network nodes, as well as in scenarios where an indirect signaling connection may exist between the network nodes, in which case intermediate network nodes may be traversed, forwarding the signaling information between the network nodes.

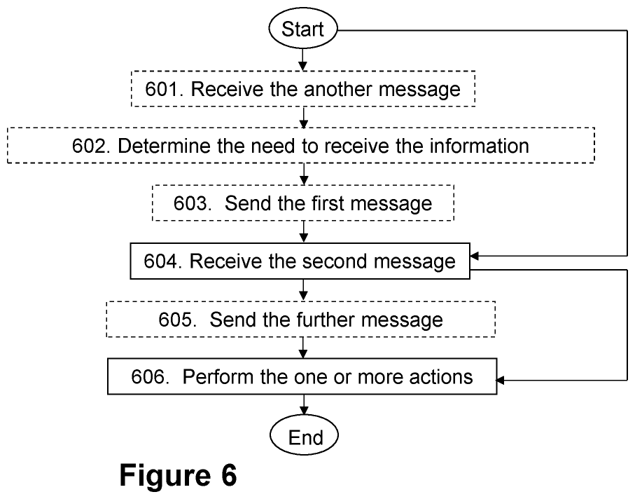

Embodiments of a method, performed by a first network node, such as the first network node 111, will now be described with reference to the flowchart depicted in FIG. 6. The method is for handling one or more reports. The first network node 111 operates in the wireless communications network 100.

Several embodiments are comprised herein. In some embodiments all the actions may be performed. In some embodiments, some of the actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first network node 111 is depicted in FIG. 6. Some actions may be performed in a different order than that shown FIG. 6.

In some embodiments, the first network node 111 may be a gNB-CU. The second network node 112 may be a gNB-DU.

In some embodiments, the wireless device 130 may be a 5G UE.

### Action 601

In this Action 601, the first network node 111 may receive, a message. The message that may be received in this Action 601 is referred to herein as “another message” or “sixth message”.

The receiving in this Action 601 may be from the second network node 112 or the third network node 113 operating in the wireless communications network 100. The receiving may be performed, e.g., via the second link 142 or the fourth link 144, respectively.

The another message may indicate the existence of one or more machine learning (ML) models available at least in part in at least one of the one or more wireless devices 130.

In some examples, one of the following may apply: a) the first network node 111 may be a gNB-CU-CP and the second network node 112 may be a gNB-DU, b) the first network node 111 may be a target node and the second network node 112 may be a source node, c) the first network node 111 may be a new node of a Retrieve UE Context procedure and the second network node 112 may be an old node of a Retrieve UE Context procedure, d) the first network node 111 may provide connectivity to a first Radio access Technology (RAT), and the second network node 112 may provide connectivity to a second RAT, and e) the first network node 111 and the second network node 112 may be involved in a multi-connectivity operation.

In some examples, the another message may be one of: i) a XnAP HANDOVER REQUEST, ii) an X2AP SGNB ADDITION REQUEST, iii) an NGAP HANDOVER REQUEST, iv) an NGAP HANDOVER REQUIRED, v) an F1AP UL RRC MESSAGE TRANSFER, vi) an F1AP INITIAL UL RRC MESSAGE TRANSFER, vii) a Radio Resource Control (RRC) message, viii) a new message referred to herein as “a third new message”, and ix) any of the preceding messages listed in i-viii for the another message, comprising another Information Element (IE) indicating one or more reports.

In a possible implementation, the another or sixth message may be realized by extending an existing message, such as an XnAP HANDOVER REQUEST, an X2AP SGNB ADDITION REQUEST, an NGAP HANDOVER REQUEST, or as a new message.

In a possible implementation, with an NG-RAN node in split architecture, the first network node 111 may be a gNB-CU-CP, the second network node 112 may be gNB-DU, and the another or sixth message may be realized by extending an existing, such as an F1AP UL RRC MESSAGE TRANSFER, an F1AP INITIAL UL RRC MESSAGE TRANSFER, or a new message

Every ML model of the one or more ML models may be understood to have a respective life cycle. Therefore, every ML model of the one or more ML models may have respective information on its respective Life-Cycle Management (LCM). In other words, every ML model of the one or more ML models may have its respective LCM information.

The one or more reports may comprise information of the respective LCM of the one or more ML models. That is the one or more reports may comprise LCM information of one or more ML models. The information may be, e.g., respective information, of the respective LCM of the one or more ML models. The one or more ML models are available, at least in part, in at least one of the one or more wireless devices 130.

### Action 602

In one example, the first network node 111, e.g., a first RAN node, or a function of a RAN node deployed in split architecture, e.g., a gNB-CU, or a OAM node, or an SMO node, or a Core Network (CN) node, may receive, e.g., from the third network node 113, an instruction indicating the need, or may determine the need to obtain report(s) comprising LCM information, e.g., testing activities, validation activities, verification activities, evaluation activities, security assessment activities, re-training, updating or modification activities, concerning AI/ML model(s) deployed in a UE, or a group of UEs.

In this Action 602, the first network node 111 may determine a need to receive respective information of the respective LCM of the one or more ML models available at least in part in the at least one of the one or more wireless devices 130.

Determining may be understood as calculating or deriving.

The determining in this Action 602 may be triggered by receiving the another message.

### Action 603

For every respective LCM of an ML of the one or more ML models, a single report, or a plurality of reports may be yield. For example, for one ML model, there may be 1 report of a first type, e.g., testing report, and another report of a second type, e.g., a verification report.

In this Action 603, the first network node 111 may send a first message.

The sending in this Action 603 may be to the second network node 112, e.g., via the second link 142.

The first message may comprise a first request to receive one or more reports. The one or more reports may comprise the respective information of the respective LCM of the one or more ML models available at least in part in at least one of the one or more wireless devices 130.

The request may be, e.g., a subscription request.

Prior to sending the first message, the first network node 111 may receive from the second network node 112 the another message, also referred to herein as the sixth message, comprising information pertaining to AI/ML model(s) deployed in the wireless device 130. The first message may be sent based on the received another message. The first network node 111 may use at least part of the information comprised in the sixth message to prepare the content of the first message. As an example, the sixth message may comprise an AI/ML model version information, indication of the wireless device 130 support for a specific AI/ML model type.

In one example, the first network node 111 may send to the second network node 112 the first message requesting to receive from the second network node 112 one or more of: a) testing report(s) for AI/ML model(s) deployed in the wireless device 130, e.g., a UE, b) verification report(s) for AI/ML model(s) deployed in the wireless device 130, c) validation report(s) for AI/ML model(s) deployed in the wireless device 130, d) evaluation report(s) for AI/ML model(s) deployed in the wireless device 130, e) security assessment report(s) for AI/ML model(s) deployed in the wireless device 130, f) training, updating, modifying report(s) for AI/ML model(s) deployed in the wireless device 130.

The first message may therefore comprise one or more of the following: a) a request to obtain from the second network node 112, or from the wireless device 130 or a group of wireless devices 130, testing reports for AI/ML model(s) deployed in the wireless device 130 or a group of wireless devices 130; b) a request to obtain from the second network node 112, or from the wireless device 130 or a group of wireless devices 130, verification report(s) for AI/ML model(s) deployed in the wireless device 130 or a group of wireless devices 130; c) a request to obtain from the second network node 112, or from the wireless device 130 or a group of wireless devices 130, validation report(s) for AI/ML model(s) deployed in the wireless device 130 or a group of wireless devices 130; d) a request to obtain from the second network node 112, or from the wireless device 130 or a group of wireless devices 130, evaluation report(s) for AI/ML model(s) deployed in the wireless device 130 or a group of wireless devices 130; e) a request to obtain from the second network node 112, or from the wireless device 130 or a group of wireless devices 130, security assessment report(s) for AI/ML model(s) deployed in the wireless device 130 or a group of wireless devices 130; f) a request to obtain from the second network node 112, or from the wireless device 130 or a group of wireless devices 130, information related to re-training, updating or modification of AI/ML models deployed in the wireless device 130 or a group of wireless devices 130, g) a request and/or a set of configuration parameters, to be sent from the second network node 112 to the wireless device 130 or a group of wireless devices 130, to obtain from the wireless device 130 or a group of wireless devices 130, test report(s) for AI/ML model(s) deployed at the one or more wireless devices 130; The second network node 112 may forward the request to the one or more wireless devices 130 as is, and/or complement it with additional information, e.g., configuration parameters, before sending it to the one or more wireless devices 130; For example, the second network node 112 may prepare an RRC message and send it to the wireless device 130, wherein the RRC message may include the request and/or the set of configuration parameters received by the first network node 111 and additional configuration parameters added by the second network node 112; h) One or more information concerning the AI/ML model(s) associated to the request(s) above, and/or one or more information the wireless device 130 for which the request(s) may be issued, such as: AI/ML model identity(ies) or identifier(s), AI/ML model vendor(s), AI/ML model version(s), AI/ML model type, application identifiers, UE model, UE vendor, UE type, UE identities or part of UE identities, e.g., in NR one of International Mobile Subscriber Identity (IMSI), International Mobile Equipment Identity (IMEI), Subscription Permanent Identifier (SUPI), Subscription Concealed Identifier (SUCI), 5G-Globally Unique Temporary UE Identity (GUTI), 5G-S-Temporary Mobile Subscriber Identity (TMSI), Type Allocation Code; i) indication of filtering criteria concerning the wireless devices 130, to be used by the second network node 112 for selecting or excluding the wireless devices 130 for which test report(s) may be requested, how many wireless devices 130, or which percentage of wireless devices 130, may be requested to provide test reports; For example, wireless devices 130 exposing certain radio capabilities, or wireless devices 130 using certain Operating System . . . ; j) an area scope, e.g., a geographical area; I) One or more data samples associated to one or more LCM operations for AI/ML models of at least one wireless device 130 in the group of: i) testing of AI/ML model, e.g., test data; ii) validation of AI/ML model, e.g., validation data; iii) verification of AI/ML model, e.g., verification data; iv) evaluation of AI/ML model, e.g., evaluation data; v) security assessment of AI/ML model, e.g., confidential data, variation of model data input resulting in adversarial machine learning attack, Denial of Service attack; and vi) training of AI/ML model, e.g., training data; m) a request to obtain from the second network node 112, or from the wireless device 130 or a group of wireless devices 130, one or more data samples associated to one or more LCM operations for AI/ML models deployed at least one wireless devices 130, wherein the requested data samples may be used for one or more LCM operations in the group of: i) testing of AI/ML model, e.g., test data; ii) validation of AI/ML model, e.g., validation data; iii) verification of AI/ML model, e.g., verification data; iv) evaluation of AI/ML model, e.g., evaluation data; v) security assessment of AI/ML model, e.g., variations of model data input; vi) (re)-training of AI/ML model, e.g., training data; n) an indication, indicating to the second network node 112 to start/stop/pause/resume/allow/prohibit sending of test report(s) for AI/ML model(s) residing in the wireless device 130; o) an indication, indicating to the second network node 112 to start/stop/pause/resume/allow/prohibit requesting further test report(s) to the wireless device 130; p) an indication, indicating to the second network node 112 to obtain the latest test report available for the wireless device 130 without requesting further test report from the wireless device 130; q) one or more conditions on the reporting, e.g., number of reports, size of reports, reporting intervals; and r) an indication or a cause indicating the reason for the request.

In a possible implementation, the first message may be realized by extending an existing message, such as an XnAP HANDOVER REQUEST ACKNOWLEDGE, an X2AP SGNB ADDITION REQUEST ACKNOWLEDGE, an NGAP HANDOVER COMMAND, an RRC message, e.g., an RRCReconfiguration message, an F1AP DL RRC MESSAGE TRANSFER, an F1AP UE CONTEXT SETUP REQUEST, an F1AP UE CONTEXT MODIFICATION REQUEST, an F1AP UE CONTEXT MODIFICATION RESPONSE, an F1AP UE CONTEXT MODIFICATION REQUIRED, or as a new message.

In a possible implementation, with an NG-RAN node in split architecture, the first network node 111 may be a gNB-CU-CP, and the second network node 112 may be gNB-DU,

In one possible implementation, the first message may comprise at least part of an RRCReconfiguration message, configuring the wireless device 130 for collecting and/or sending test reports for AI/ML model(s) residing in the wireless device 130.

The methods of the described embodiments and the related signaling may be part of an already existing signaling procedures. Some non-limiting examples are provided below.

In a first group of examples, the methods of the described embodiments and the related signaling may be part of a mobility procedure(s) that may be undergoing for the wireless device 130 for which the test report(s) may be requested. In one example, the first network node 111 may be the target node of a handover procedure and it may indicate to the source node a request to obtain from the source node one test report, e.g., the latest test report available at the source node, for an AI/ML model deployed at the wireless device 130. In another example, the first network node 111 may be the target node of a handover procedure and it may send a request or configuration parameters to the wireless device 130, via the source node, to obtain from the wireless device 130 test report(s) for an AI/ML model deployed at the wireless device 130. In another example, the first network node 111 may be the new node of a Retrieve UE Context procedure and it may send a request to the old node of the Retrieve UE Context procedure, to obtain from the old node test report(s), e.g., the latest test report available at the old node, for an AI/ML model deployed at the wireless device 130. In another example, the first network node 111 may provide radio connectivity for the wireless device 130 in a first Radio Access Technology, e.g., E-UTRA, or NR, or WiFi, or 6G, and the second network node 112 may provide radio connectivity for the U wireless device 130 E in a second Radio Access Technology, e.g., E-UTRA, or NR, or WiFi, or 6G, and a radio procedure may be ongoing between the first network node 111 and the second network node 112.

In a second group of examples, the methods of the described embodiments and the related signaling may be part of an initial UE context setup may be ongoing for the wireless device 130. In one example for NR, the first network node 111 may be one of the function of an NG-RAN node, such as the gNB-CU and the second network node 112 may be another function of the same NG-RAN node, such as one of the gNB-DU of the NG-RAN node.

In a third group of examples, the methods of the described embodiments and the related signaling may be part of a multi-connectivity procedure that may be undergoing for the wireless device 130. In one example, the first network node 111 may be one of the RAN nodes involved in a multi-connectivity operation for UE(s). Some examples may be the target Master Node in an “Inter-Master Node handover with/without Secondary Node change” procedure, as described in 3GPP TS 37.340 v16.8.0, clause 10.7 or the target Secondary Node in a “Secondary Node Change (MN/SN initiated)” procedure, as described in 3GPP TS 37.340 v16.8.0, clause 10.5.

Further details on the content of the first message are provided in the next Action.

### Action 604

In this Action 604, the first network node 111 receives a message.

The receiving in this Action 604 may be from at least one of the second network node 112 and the one or more wireless devices 130 operating in the wireless communications network 100.

The message comprises the one or more reports. The one or more reports comprise the information. The information may be of the respective LCM of the one or more ML models. That is, the one or more reports may comprise the LCM information of the one or more ML models. The information may be, e.g., the respective information, of the respective LCM of the one or more ML models. The one or more ML models are available, at least in part, in at least one of the one or more wireless devices 130. That is, the one or more ML models may be deployed, e.g., residing, and used, at the one or more wireless devices 130. For example, one ML model, or more, may be deployed at least in part, and used, at one wireless device 130.

“Available at least in part”, or deployed at least in part, may be understood to mean that, for example, a first “inference” function may be deployed in the wireless device 130, which first inference function may be used together with another inference function, deployed in a network node.

The receiving from the one or more wireless devices 130 may be performed, e.g., via the respective first link 141. The receiving from the second network node 112 may be performed, e.g., via the second link 142.

Different wireless devices of the one or more wireless devices 130 may yield a different number of reports, and the reports may be received together in the message in this Action 604. For example, the message may comprise 1 report from a first wireless device, e.g., UE1, of type x, e.g., a testing report, 1 report from the first wireless device, UE1, of type y, e.g., a verification report, and 1 report from a second wireless device, e.g., UE2, of type x, e.g., a testing report.

Hence, the expression “one or more reports comprising respective information of a respective LCM of one or more ML models” may be understood to mean that every report, of the one or more reports, may comprise information pertaining to a particular LCM of one of the ML models. Then, several reports, of several respective LCM, of several ML models, which may reside in different wireless devices, may be comprised in the message received in this Action 604.

Expressed differently, every model ML “x” may have 1 LCMx, and every report x may have information x, that is, “respective” information, regarding that LCMx, that is, “respective” LCM. Therefore, if in 1 message the first network node 111 receives multiple reports N, from the same wireless device 130, or several wireless devices, every report n may be understood to have “respective” information n of 1 “respective” LCM.

The message may comprise one or more reports comprising respective information of the respective LCM of a respective ML model, of the one or more ML models, of a respective wireless device, of the one or more wireless devices 130.

In some embodiments, the one or more reports may comprise at least one of: a) a testing report of at least one of the one or more ML models, b) a verification report of at least one of the one or more ML models, c) a validation report of at least one of the one or more ML models, d) an evaluation report of at least one of the one or more ML models, e) a security assessment report of at least one of the one or more ML models, and f) a report of training, updating, or modifying at least one of the one or more ML models.

The message received in this Action 604 may comprise at least one of: a) one or more first indications of a respective identifier or identity of the one or more ML models, b) one or more second indications of a respective vendor of the one or more ML models, c) one or more third indications of a respective version of the one or more ML models, d) one or more fourth indications of a type of the one or more ML models, e) one or more fifth indications of a respective Operating System of the one or more wireless devices 130, f) one or more sixth indications of a respective identifier of one or more applications the one or more ML models relate to, g) one or more seventh indications of a respective identifier of one or more use cases the one or more ML models relate to, h) one or more eighth indications of a respective identifier of one or more services or service types the one or more ML models relate to, i) one or more ninth indications of a respective identifier of one or more network slices the one or more ML models relate to, j) a cause value indicating a reason for a failure/reject, and k) one or more data samples associated to one or more LCM operations for the one or more ML models available at least in part in at least one of the one or more wireless devices 130 of: i) testing of the one or more ML models, ii) validation of the one or more ML models, iii) verification of the one or more ML models, iv) evaluation of the one or more ML models, v) security assessment of the one or more ML models, and vi) training of the one or more ML models.

In some examples, the message may be understood to be a second message.

Therefore, the first network node 111 may receive the second message comprising an LCM report, wherein the LCM report may consist of one or more of: i) testing report(s) for AI/ML model(s) deployed in the wireless device 130; ii) verification report(s) for AI/ML model(s) deployed in the wireless device 130; iii) validation report(s) for AI/ML model(s) deployed in the wireless device 130; iv) evaluation report(s) for AI/ML model(s) deployed in the wireless device 130; v) security assessment report(s) for AI/ML model(s) deployed in the wireless device 130; and vi) One or more reports associated to training, updating, modifying report(s) for AI/ML model(s) deployed in the wireless device 130.

In one example, the second message may additionally comprise one or more of: a) indication, implicit or explicit, of success, b) indication, implicit or explicit, of failure or reject, c) indication of no support, d) indication(s) of AI/ML model identity(ies) or identifier(s), e) indication(s) of AI/ML model vendor(s), f) indication(s) of AI/ML model version(s), g) indication(s) of AI/ML model type, h) indication of Operating System of the wireless devices 130, i) indication of application identifiers, j) cause value indicating the reason for a failure/reject, I) One or more data samples associated to one or more LCM operations for AIML models of at least one UE in the group of: i) testing of AIML model, e.g., test data; ii) validation of AIML model, e.g., validation data; iii) verification of AIML model, e.g., verification data; iv) evaluation of AIML model, e.g., evaluation data; v) training of AIML model, e.g., training data.

In one variant, the first network node 111 may receive from the second network node 112 the second message, comprising report(s) comprising LCM information for AI/ML model(s) deployed at the one or more wireless devices 130, already available at the second network node 112 or indication(s) of failure(s).

In another variant, the second network node 112 may send second message(s) to the first network node 111 comprising the obtained report(s) or indication(s) of failures, after the second network node 112 may have requested them from the one or more wireless devices 130.

In another variant, the second network node 112 may forward the second message, which it may have received from the one or more wireless devices 130.

The second message may be received in response to the sent first message.

In one example of the method, the first network node 111 may receive the second message from the second network node 112 upon transmitting a first message to the second network node 112 requesting for life cycle management information associated to one or more user devices. In some examples, the user devices may be under the coverage of one or more radio cells of the second network node 112. In this case, the first network node 111 may receive the second message from the second network node 112 in response to prior transmitting the first message to the second network node 112.

In some embodiments, the first message may further comprise at least one of: a) at least one of a first request and a set of configuration parameters to be sent from the second network node 112 to the one or more wireless devices 130 to obtain the one or more reports, b) one or more indications, referred to herein as “thirteenth indications”, of a respective one or more of model, vendor and type of the one or more wireless devices 130, c) one or more indications, referred to herein as fourteenth indications, of a respective identity of the one or more wireless devices 130, d) one or more indications, referred to herein as fifteenth indications, of respective criteria to select the one or more wireless devices 130, e) an indication, referred to herein as “a sixteenth indication”, of an area of scope, f) a second request to obtain, from the second network node 112 or from the at least one of the one or more wireless devices 130, one or more data samples associated to one or more LCM operations for the one or more ML models, of at least one of the one or more wireless devices 130, of: i) testing of the one or more ML models, ii) validation of the one or more ML models, iii) verification of the one or more ML models, iv) evaluation of the one or more ML models, v) security assessment of the one or more ML models, and vi) training of the one or more ML models, g) an indication, referred to herein as “a seventeenth indication”, indicating to one of: start, stop, pause, resume, allow and prohibit sending any or all of the one or more reports, h) an indication, referred to herein as “an eighteenth indication”, indicating to one of: start, stop, pause, resume, allow and prohibit requesting additional one or more reports comprising respective information of a respective LCM of one or more ML models, to at least one of the one or more wireless devices 130, i) an indication, referred to herein as “a nineteenth indication”, indicating to the second network node 112 to obtain the latest test report available for at least one of the one or more wireless devices 130, without requesting further test reports from the at least one of the one or more wireless devices 130, j) one or more conditions on the reporting, and k) an indication, referred to herein as “a twentieth indication”, of a reason for requesting the one or more reports.

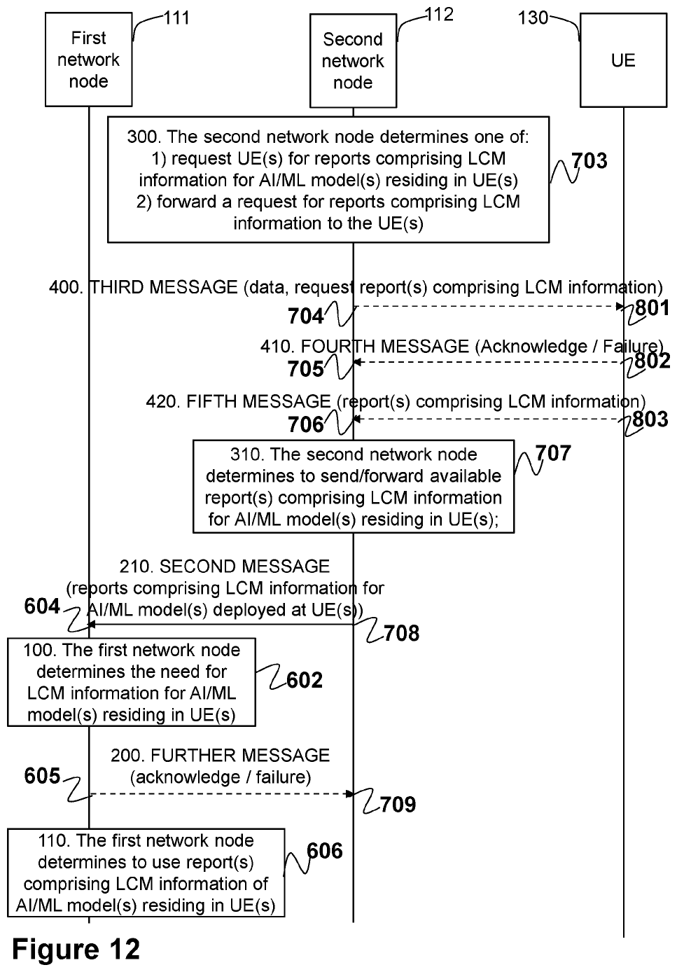

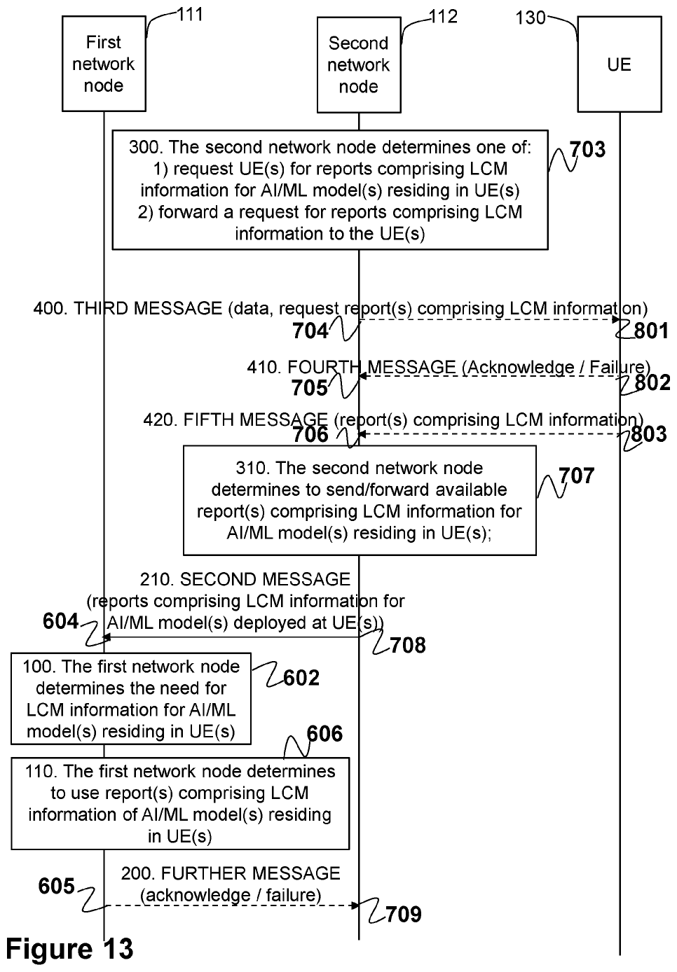

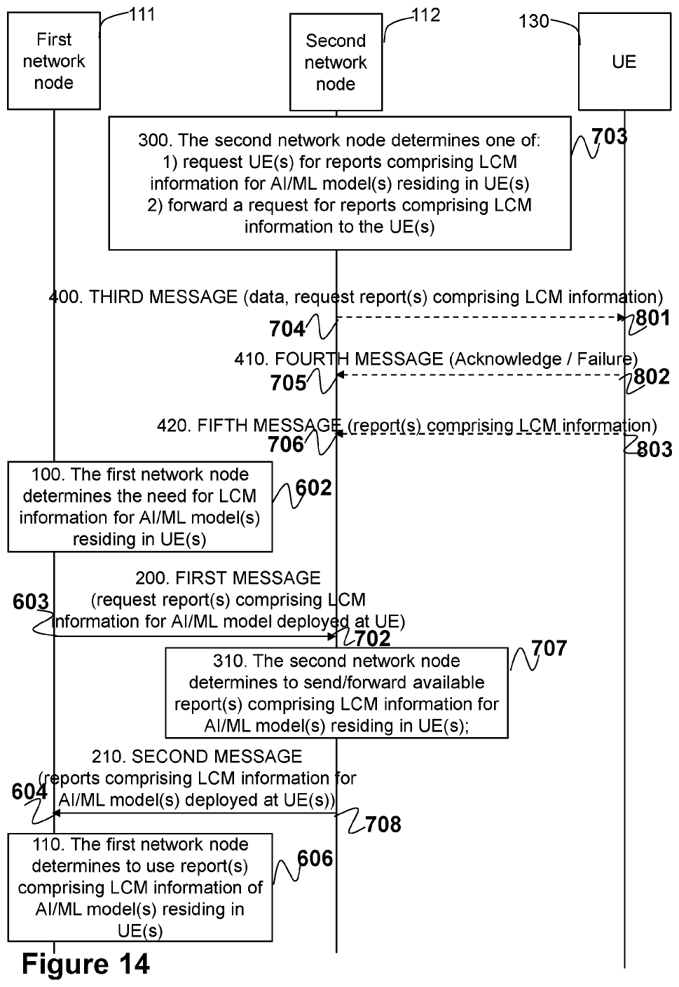

In one example of the method, illustrated in FIG. 12, FIG. 13 and FIG. 14, the first network node 111 may receive the second message from the second network node 112 without prior transmitting the first message to the second network node 112 requesting for life cycle management information associated to the one or more wireless devices 130. In this case, the second network node 112 may provide life cycle management information associated to the one or more wireless devices 130 independently of the first network node 111. For instance, the second network node 112 may provide life cycle management information associated to the one or more wireless devices 130 as part of a handover request or as part of a UE Context Setup Request, or UE Context Modification Request transmitted to the first network node 111.

In one example of embodiments herein, illustrated in FIG. 9, the first network node 111 may receive the second message from the second network node 112.

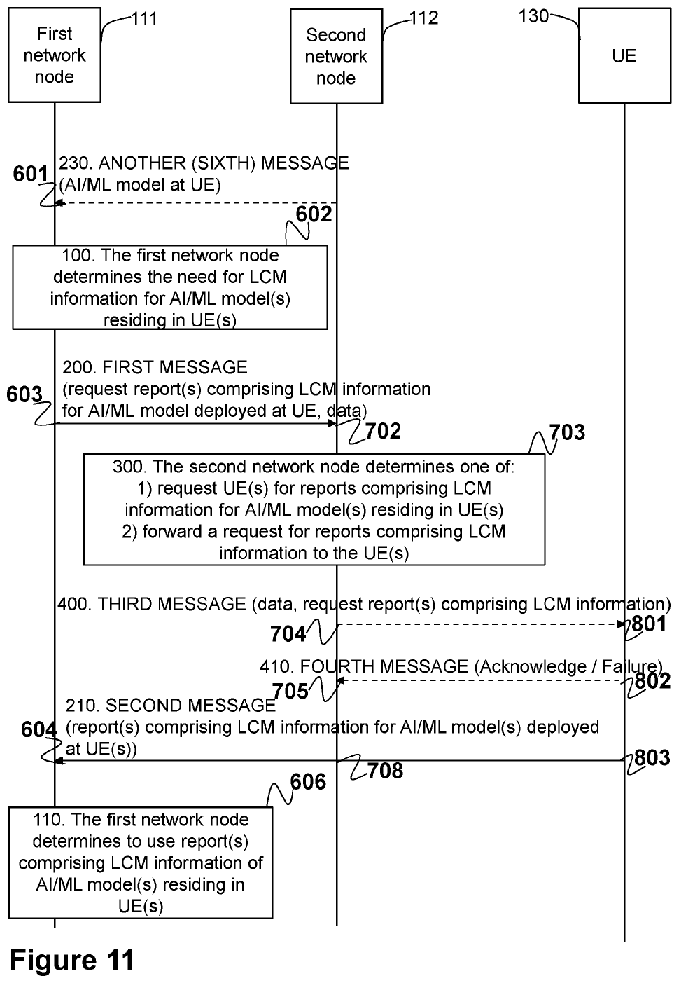

In another example of embodiments herein, illustrated in FIG. 11, the first network node 111 may receive the second message from the wireless device 130.

Therefore, in some cases report(s) comprising LCM information for AI/ML models deployed at the one or more wireless devices 130 may be sent from the wireless device 130 to the first network node 111 via the second network node 112, or directly from the wireless device 130 to the first network node 111.

The second message may comprise the one or more reports requested by the first network node 111.

In some examples, at least one of the following two options may apply. According to a first option, the first message may be one of: i) an XnAP HANDOVER REQUEST ACKNOWLEDGE, ii) an X2AP SGNB ADDITION REQUEST ACKNOWLEDGE, iii) an NGAP HANDOVER COMMAND, iv) a Radio Resource Control, RRC, message, v) an F1AP DL RRC MESSAGE TRANSFER, vi) an F1AP UE CONTEXT SETUP REQUEST, vii) an F1AP UE CONTEXT MODIFICATION REQUEST, viii) an F1AP UE CONTEXT MODIFICATION RESPONSE, ix) an F1AP UE CONTEXT MODIFICATION REQUIRED, x) an F1AP UE CONTEXT MODIFICATION CONFIRM, xi) an E1AP BEARER CONTEXT SETUP REQUEST, xii) an E1AP BEARER CONTEXT MODIFICATION REQUEST, xiii) an E1AP BEARER

CONTEXT MODIFICATION REQUIRED, xiv) an E1AP BEARER CONTEXT MODIFICATION CONFIRM, xv) an E1AP BEARER CONTEXT SETUP RESPONSE, xvi) an E1AP BEARER CONTEXT MODIFICATION RESPONSE, xvii) a first new message, xviii) comprises at least a part of an RRCReconfiguration message, and xix) any of the preceding messages listed in i-xviii for the first message, comprising a first Information Element, IE, indicating the one or more reports.

According to a second option, the second message may be one of: i) an RRCReconfigurationComplete message, ii) an XnAP ACCESS AND MOBILITY INFORMATION, iii) an XnAP HANDOVER REPORT, iv) an XnAP RRC TRANSFER, v) an XnAP HANDOVER REQUEST, vi) an NGAP HANDOVER REQUEST, vii) an NGAP HANDOVER REQUIRED, viii) an F1AP UL RRC MESSAGE TRANSFER, ix) an F1AP UE CONTEXT SETUP RESPONSE, x) an F1AP UE CONTEXT MODIFICATION RESPONSE, xi) an F1AP UE CONTEXT MODIFICATION REQUIRED, xii) an F1AP UE CONTEXT MODIFICATION CONFIRM, xiii) an F1AP UE CONTEXT SETUP REQUEST, xiv) an F1AP UE CONTEXT MODIFICATION REQUEST, xv) an E1AP BEARER CONTEXT SETUP

REQUEST, xvi) an E1AP BEARER CONTEXT MODIFICATION REQUEST, xvii) an E1AP BEARER CONTEXT MODIFICATION REQUIRED, xviii) an E1AP BEARER CONTEXT MODIFICATION CONFIRM, xix) an E1AP BEARER CONTEXT SETUP RESPONSE, xx) an E1AP BEARER CONTEXT MODIFICATION RESPONSE, xxi) an RRC, message, xxii) a second new message, and xxiii) any of the preceding messages listed in i-xxii for the second message, comprising a second IE indicating the one or more reports.

In a possible implementation, the second message may be realized by extending an existing message, such as an RRC RRCReconfigurationComplete message, an XnAP ACCESS AND MOBILITY INFORMATION, an XnAP HANDOVER REPORT, an XnAP RRC TRANSFER, an XnAP HANDOVER REQUEST or in a new message.

In another possible implementation, with an NG-RAN node in split architecture, the first network 111 node may be a gNB-CU-CP, the second network node 112 may be gNB-DU, and the second message may be realized by extending an existing message, such as an F1AP UL RRC MESSAGE TRANSFER, an F1AP UE CONTEXT SETUP RESPONSE, an F1AP UE CONTEXT MODIFICATION RESPONSE, an F1AP UE CONTEXT MODIFICATION REQUIRED, an F1AP UE CONTEXT SETUP REQUEST, an F1AP UE CONTEXT MODIFICATION REQUEST, or in a new message.

### Action 605

In some embodiments, in this Action 605, the first network node 111 may send a further message. The sending in this Action 605 may be to the one of the second network node 112 and the one or more wireless devices 130. Sending may be understood as transmitting, or providing, e.g., via the second link 142, and the respective first link 141, respectively.

The sending in this Action 605 may be in response to the received second message.

The further message may comprise at least one of: i) a tenth indication, implicit or explicit, of success, ii) an eleventh indication, implicit or explicit, of failure or reject, and iii) a twelfth indication of no support.

### Action 606

In this Action 606, the first network node 111 performs one or more actions.

The performing in this Action 606 of the one or more actions uses the information comprised in at least one of the one or more reports.

The one or more actions comprise at least one of: retraining or triggering a retraining of at least one of the one or more ML models, updating or triggering an update of at least one of the one or more ML models, deploying or triggering a deployment of an additional ML model, revoking or triggering a revocation of at least one of the one or more ML models, forwarding the one or more reports to the third network node 113 operating in the wireless communications network 100, and completing an ongoing procedure handled by the first network node 111.

The ongoing procedure may be one of: a handover execution, a handover preparation, a UE context modification, a UE context setup, an intra-RAT mobility, an inter-RAT mobility, an inter-system mobility, a Radio Resource Control (RRC) connection establishment, an RRC connection resume, an RRC reconfiguration, an RRC connection re-establishment, a retrieve UE context, an initial UE context setup, a bearer context setup, a bearer context modification, and a multi-connectivity procedure

In one example of embodiments herein, the first network node 111 may determine one or more actions based at least in part on the received report(s) comprising life cycle management information associated to AI/ML model(s) deployed at the one or more wireless devices 130, wherein an action may be one of: retrain or trigger a retraining for the AI/ML model, update or trigger an update of the AI/ML model, deploy or trigger a deployment of a new AI/ML model, revoke or trigger a revoke for the AI/ML model, forward the report(s) to the third network node 113, use one or more of the received reports for completing, successfully or unsuccessfully, an action, e.g., completing an ongoing procedure, such as a handover execution, a handover preparation, a UE context modification, a UE context setup.

Examples of these actions and the messages and indications are provided later in this document.

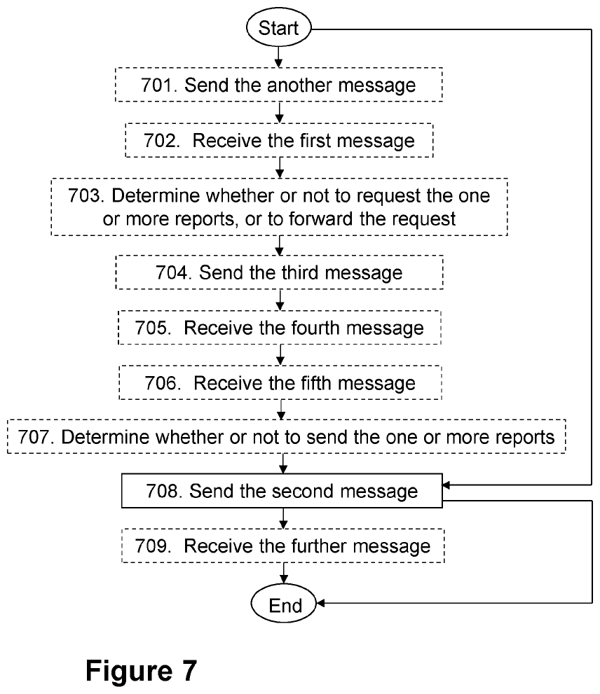

Embodiments of a method, performed by a second network node, such as the second network node 112, will now be described with reference to the flowchart depicted in FIG. 7. The method may be understood to be for handling the one or more reports. The second network node 112 operates in the wireless communications network 100.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second network node 112 is depicted in FIG. 7. Some actions may be performed in a different order than that shown FIG. 7. The detailed description of some of the following corresponds to the same references provided above, in relation to the actions described for the first network node 111 and will thus not be repeated here to simplify the description. For example, in some embodiments, the first network node 111 may be a gNB-CU, the second network node 112 may be a gNB-DU, and the wireless device 130 may be a 5G UE.

The examples for the first network node 111 comprising the second network node 112 may be understood to be mirrored for the second network node 112.

### Action 701

In this Action 701, the second network node 112 may send the another message.

The sending in this Action 701 may be to the first network node 111. The sending may be performed, e.g., via the second link 142.

The another message may indicate the existence of the one or more ML models available at least in part in the at least one of the one or more wireless devices 130.

In some examples, the another message may be one of: i) the XnAP HANDOVER REQUEST, ii) the X2AP SGNB ADDITION REQUEST, iii) the NGAP HANDOVER REQUEST, iv) the NGAP HANDOVER REQUIRED, v) the F1AP UL RRC MESSAGE TRANSFER, vi) the F1AP INITIAL UL RRC MESSAGE TRANSFER, vii) the RRC message, viii) the third new message, and ix) any of the preceding messages listed in i-viii for the another message, comprising another IE indicating the one or more reports.

In some examples, one of the following may apply: a) the first network node 111 may be the gNB-CU-CP and the second network node 112 may be the gNB-DU, b) the first network node 111 may be the target node and the second network node 112 may be the source node, c) the first network node 111 may be the new node of a Retrieve UE Context procedure and the second network node 112 may be the old node of a Retrieve UE Context procedure, d) the first network node 111 may provide connectivity to the first RAT, and the second network node 112 may provide connectivity to the second RAT, and e) the first network node 111 and the second network node 112 may be involved in the multi-connectivity operation.

### Action 702

In some embodiments, in this Action 702, the second network node 112 may receive the first message.

The receiving in this Action 702 may from the first network node 111, e.g., via the second link 142.

The first message may comprise the first request to receive the one or more reports. The one or more reports may comprise the respective information of the respective LCM of the one or more ML models available at least in part in at least one of the one or more wireless devices 130.

The first message may be received based on the sent another message.

### Action 703

In some embodiments, in this Action 703, the second network node 112 may determine, whether or not one of: i) to request the one or more reports from the one or more wireless devices 130, and ii) to forward the request comprised in the received first message to the one or more wireless devices 130.

### Action 704

In this Action 704, the second network node 112 may send a third message.

The sending in this Action 704 may be, respectively, to the one or more wireless devices 130. The sending may be performed, e.g., via the respective third link 143.

The third message may one of: i) comprise, indicate or forward the first request comprised in the received first message, and ii) comprise another request to receive the one or more reports comprising the respective information of the respective LCM of the one or more ML models available at least in part in at least one of the one or more wireless devices 130; the another request may be independent of having received or not the first message from the first network node 111.

In some examples, an LCM information report may comprise one or more of: testing report(s) for AI/ML model(s) deployed in the one or more wireless devices 130, verification report(s) for AI/ML model(s) deployed in the one or more wireless devices 130, validation report(s) for AI/ML model(s) deployed in the one or more wireless devices 130, evaluation report(s) for AI/ML model(s) deployed in the one or more wireless devices 130, security assessment report(s) for AI/ML model(s) deployed in the one or more wireless devices 130, and training, updating, modifying report(s) for AI/ML model(s) deployed in the one or more wireless devices 130.

In a possible implementation, the third message may be realized by extending an existing RRC RRCReconfiguration message, or in a new message.

### Action 705

In this Action 705, the second network node 112 may receive a fourth message.

The receiving in this Action 705 may be, respectively, from the one or more wireless devices 130. The fourth message may indicate an acknowledgement, failure or a reject of the sent third message.

The second network node 112 may receive from the wireless device 130 the fourth message to indicate an acknowledge or a failure or a reject in response to the third message. In a possible implementation, the fourth message may be realized by extending an existing RRC RRCReconfigurationComplete message, an RRC RRCReject message or in a new message.

### Action 706

In this Action 706, the second network node 112 may receive a fifth message.

The receiving in this Action 706 may be, respectively, from the one or more wireless devices 130.

The fifth message may comprise one of: a) the one or more reports, wherein the second message may be sent, as will be described in Action 708, comprising the one or more repots comprised in the fifth message, and b) the second message, wherein the second network node 112 may relay the received second message to the first network node 111, as will be described in Action 708.

The second network node 112 may receive from the wireless device 130 the fifth message comprising report(s) comprising LCM information as originally requested by the first network node 111. In a possible implementation, the fifth message may be realized by extending an existing RRC RRCReconfigurationComplete message, or in a new message.

### Action 707

In this Action 707, the second network node 112 may determine whether or not to send the one or more reports comprising the respective information of the respective LCM of the one or more ML models available at least in part in at least one of the one or more wireless devices 130, to the first network node 111.

In one example, the second network node 112 may determine one or more of the following actions: (a) send, according to Action 708, as determined according to this Action 707, to the first network node 111 report(s) comprising life cycle management information for AI/ML model(s) deployed in the one or more wireless devices 130, (b) request, according to Action 704 as determined according to this Action 703, to the wireless device 130 or a group of wireless devices 130, report(s) comprising life cycle management information for an AI/ML model(s) deployed in the one or more wireless devices 130, and (c) forward, according to Action 708 as determined according to this Action 703, to the wireless device 130, the request for report(s) comprising life cycle management information for UE AI/ML model(s) deployed in the one or more wireless devices 130.

In one example, if the second network node 112 has already one or more report(s) comprising LCM information available, e.g., stored in a memory, or in an internal database or retrieved from an external database, it may perform action (a) and then optionally execute action (b) to request to the one or more wireless devices 130 further test reports.

In another example, if action (a) is not initially possible, e.g., there is no report(s) comprising LCM information available at the second network node 112, or if there are, they do not satisfy the conditions indicated in the first message, then action (b) may be performed, potentially multiple times, e.g., to obtain more reports from a plurality of UEs), then followed by action (a).

In another example, action (c) may be performed, and the second network node may insert in the third message to be sent to the wireless device 130, part of the first message, which may be opaque to the second network node 112.

The second network node 112 may optionally send to the wireless device 130 or a group of wireless device 130 the third message comprising at least in part the content received in the first message.

### Action 708

In this Action 708, the second network node 112 sends a message, e.g., the second message.

The sending in this Action 704 is to the first network node 111 operating in the wireless communications network 100.

The sending may be performed, e.g., via the second link 142.

The message comprises the one or more reports. The one or more reports comprise the respective information. The respective information is of the respective LCM of the one or more ML models. That is, the one or more reports may comprise LCM information of one or more ML models. The information may be, e.g., the respective information, of the respective LCM of the one or more ML models.

The message may comprise one or more reports comprising respective information of the respective LCM of a respective ML model, of the one or more ML models, of a respective wireless device, of the one or more wireless devices 130.

The one or more ML models are available at least in part in the at least one of the one or more wireless devices 130 operating in the wireless communications network 100.

In some embodiments, the one or more reports may comprise at least one of: i) the testing report of at least one of the one or more ML models, ii) the verification report of at least one of the one or more ML models, iii) the validation report of at least one of the one or more ML models, iv) the evaluation report of at least one of the one or more ML models, v) the security assessment report of at least one of the one or more ML models, and vi) the report of training, updating, or modifying at least one of the one or more ML models.

The information, that is, the respective information, may be to enable the first network node 111 to perform the one or more actions. The one or more actions may comprise at least one of: a) retraining or triggering the retraining of at least one of the one or more ML models, b) updating or triggering the update of at least one of the one or more ML models, c) deploying or triggering the deployment of the additional ML model, d) revoking or triggering the revocation of at least one of the one or more ML models, e) forwarding the one or more reports to the third network node 113 operating in the wireless communications network 100, and f) completing the ongoing procedure handled by the first network node 111.

The ongoing procedure may be one of: the handover execution, the handover preparation, the UE context modification, the UE context setup, the intra-RAT mobility, the inter-RAT mobility, the inter-system mobility, the RRC connection establishment, the RRC connection resume, the RRC reconfiguration, the RRC connection re-establishment, the retrieve UE context, the initial UE context setup, the bearer context setup, the bearer context modification, and the multi-connectivity procedure.

The message may comprise at least one of: a) the one or more first indications of the respective identifier or identity of the one or more ML models, b) the one or more second indications of the respective vendor of the one or more ML models, c) the one or more third indications of the respective version of the one or more ML models, d) the one or more fourth indications of the type of the one or more ML models, e) the one or more fifth indications of the respective Operating System of the one or more wireless devices 130, f) the one or more sixth indications of the respective identifier of the one or more applications the one or more ML models may relate to, g) the one or more seventh indications of the respective identifier of the one or more use cases the one or more ML models may relate to, h) the one or more eighth indications of the respective identifier of one or more services or service types the one or more ML models may relate to, i) the one or more ninth indications of the respective identifier of the one or more network slices the one or more ML models may relate to, j) the cause value indicating the reason for the failure/reject, and k) the one or more data samples associated to the one or more LCM operations for the one or more ML models available at least in part in at least one of the one or more wireless devices 130 of: i) testing of the one or more ML models, ii) validation of the one or more ML models, iii) verification of the one or more ML models, iv) evaluation of the one or more ML models, v) security assessment of the one or more ML models, and vi) training of the one or more ML models.

The second message may be sent in response to the received first message.

The second message may comprise the one or more reports requested by the first network node 111.

### Action 709

In this Action 709, the second network node 112 may receive the further message.

The receiving in this Action 709 may be from the first network node 111.

The receiving in this Action 709 may be in response to the sent second message.

The further message may comprise at least one of: i) the tenth indication, implicit or explicit, of success, ii) the eleventh indication, implicit or explicit, of failure or reject, and iii) the twelfth indication of no support.

In some examples, the first message may further comprise at least one of: a) at least one of the first request and the set of configuration parameters to be sent from the second network node 112 to the one or more wireless devices 130 to obtain the one or more reports, b) the one or more thirteenth indications of the respective one or more of model, vendor and type of the one or more wireless devices 130, c) the one or more fourteenth indications of the respective identity of the one or more wireless devices 130, d) the one or more fifteenth indications of the respective criteria to select the one or more wireless devices 130, e) the sixteenth indication of the area of scope, f) the second request to obtain, from the second network node 112 or from the at least one of the one or more wireless devices 130, one or more data samples associated to the one or more LCM operations for the one or more ML models, of at least one of the one or more wireless devices 130, of: i) testing of the one or more ML models, ii) validation of the one or more ML models, iii) verification of the one or more ML models, iv) evaluation of the one or more ML models, v) security assessment of the one or more ML models, and vi) training of the one or more ML models, g) the seventeenth indication indicating to one of: start, stop, pause, resume, allow and prohibit sending any or all of the one or more reports, h) the eighteenth indication indicating to one of: start, stop, pause, resume, allow and prohibit requesting the additional one or more reports comprising respective information of the respective LCM of one or more ML models, to at least one of the one or more wireless devices 130, i) the nineteenth indication indicating to the second network node 112 to obtain the latest test report available for at least one of the one or more wireless devices 130, without requesting further test reports from the at least one of the one or more wireless devices 130, j) the one or more conditions on the reporting, and k) the twentieth indication of the reason for requesting the one or more reports.

In some examples, at least one of the following may apply: a) the first message may be one of: i) the XnAP HANDOVER REQUEST ACKNOWLEDGE, ii) the X2AP SGNB ADDITION REQUEST ACKNOWLEDGE, iii) the NGAP HANDOVER COMMAND, iv) the Radio Resource Control, RRC, message, v) the F1AP DL RRC MESSAGE TRANSFER, vi) the F1AP UE CONTEXT SETUP REQUEST, vii) the F1AP UE CONTEXT MODIFICATION REQUEST, viii) the F1AP UE CONTEXT MODIFICATION RESPONSE, ix) the F1AP UE CONTEXT MODIFICATION REQUIRED, x) the F1AP UE CONTEXT MODIFICATION CONFIRM, xi) the E1AP BEARER CONTEXT SETUP REQUEST, xii) the E1AP BEARER CONTEXT MODIFICATION REQUEST, xiii) the E1AP BEARER CONTEXT MODIFICATION REQUIRED, xiv) the E1AP BEARER CONTEXT MODIFICATION CONFIRM, xv) the E1AP BEARER CONTEXT SETUP RESPONSE, xvi) the E1AP BEARER CONTEXT MODIFICATION RESPONSE, xvii) the first new message, xviii) comprises at least the part of the RRCReconfiguration message, and xix) any of the preceding messages listed in i-xviii for the first message, comprising the first IE indicating the one or more reports, b) the second message may be one of: i) the RRCReconfigurationComplete message, ii) the XnAP ACCESS AND MOBILITY INFORMATION, iii) the XnAP HANDOVER REPORT, iv) the XnAP RRC TRANSFER, v) the XnAP HANDOVER REQUEST, vi) the NGAP HANDOVER REQUEST, vii) the NGAP HANDOVER REQUIRED, viii) the F1AP UL RRC MESSAGE TRANSFER, ix) the F1AP UE CONTEXT SETUP RESPONSE, x) the F1AP UE CONTEXT MODIFICATION

RESPONSE, xi) the F1AP UE CONTEXT MODIFICATION REQUIRED, xii) the F1AP UE CONTEXT MODIFICATION CONFIRM, xiii) the F1AP UE CONTEXT SETUP REQUEST, xiv) the F1AP UE CONTEXT MODIFICATION REQUEST, xv) the E1AP BEARER CONTEXT SETUP REQUEST, xvi) the E1AP BEARER CONTEXT MODIFICATION REQUEST, xvii) the E1AP BEARER CONTEXT MODIFICATION REQUIRED, xviii) the E1AP BEARER CONTEXT MODIFICATION CONFIRM, xix) the E1AP BEARER CONTEXT SETUP RESPONSE, xx) the E1AP BEARER CONTEXT MODIFICATION RESPONSE, xxi) the RRC message, xxii) the second new message, and xxiii) any of the preceding messages listed in i-xxii for the second message, comprising the second IE indicating the one or more reports.

Examples of these actions and the messages and indications are provided later in this document.

The actions listed above may be understood to not be intended as mutually exclusive and may be repeated multiple times in any order. Which action(s) may be executed may depend on the instructions received by the second network node 112 in the first message.

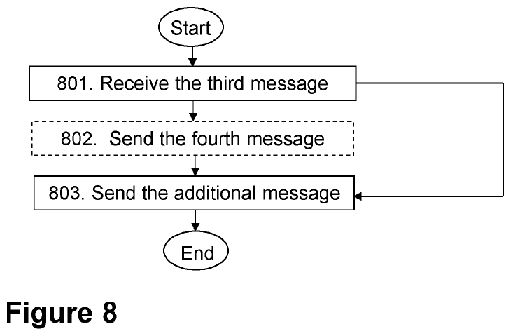

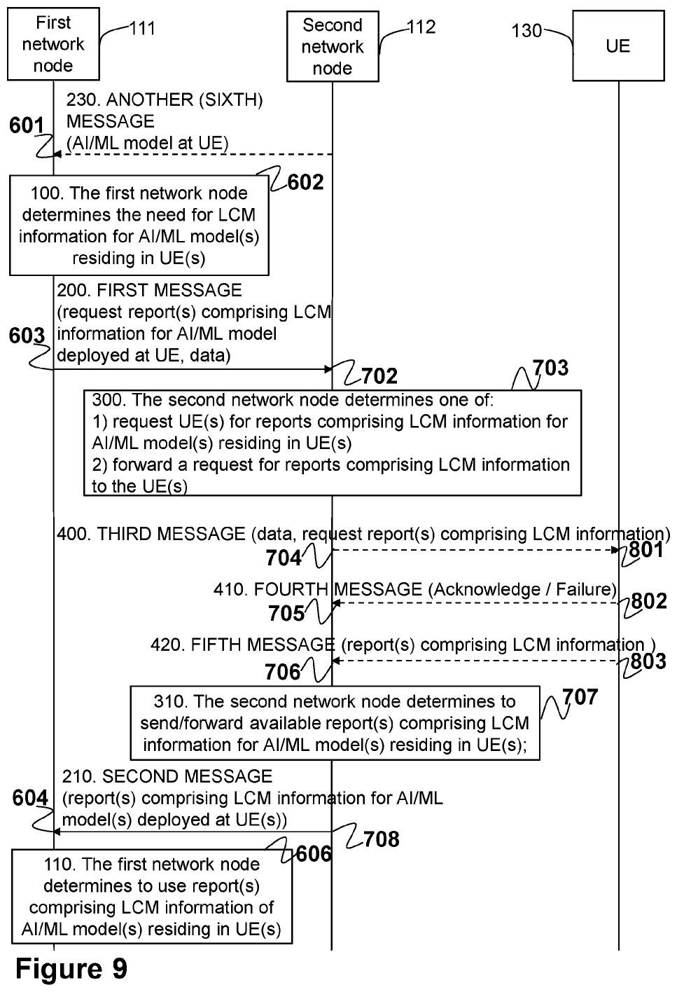

Embodiments of a method, performed by a wireless device, such as the wireless device 130, will now be described with reference to the flowchart depicted in FIG. 8. The wireless device 130 operates in the wireless communications network 100. The method may be understood to be for handling the one or more reports.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the wireless device 130 is depicted in FIG. 8. Some actions may be performed in a different order than that shown in FIG. 8. The detailed description of some of the following corresponds to the same references provided above, in relation to the actions described for the first network node 111 and will thus not be repeated here to simplify the description. For example, in some embodiments, the first network node 111 may be a gNB-CU, the second network node 112 may be a gNB-DU, and the wireless device 130 may be a 5G UE.

### Action 801

In this Action 801, the wireless device 130 receives the third message.

The receiving in this Action 801 may be from the second network node 112 operating in the wireless communications network 100.

The receiving in this Action 801 may be performed, e.g., via the respective third link 143.

The third message comprises a request, that is, the another request, to receive the one or more reports comprising the information, e.g., the one or more reports comprising the respective information of the respective LCM of the one or more ML models. The one or more ML models are available at least in part in the wireless device 130. That is, the third message may comprise at least a request of life cycle management information associated to one or more AI/ML model(s) deployed in the wireless device 130.

The requested report(s) comprising LCM information associated to one or more AI/ML model(s) deployed in the one or more wireless devices 130, may comprise one or more of: the testing report(s) for AI/ML model(s) deployed in the one or more wireless devices 130, the verification report(s) for AI/ML model(s) deployed in the one or more wireless devices 130, the validation report(s) for AI/ML model(s) deployed in the one or more wireless devices 130, the evaluation report(s) for AI/ML model(s) deployed in the one or more wireless devices 130, the security assessment report(s) for AI/ML model(s) deployed in the one or more wireless devices 130, and the training, updating, modifying report(s) for AI/ML model(s) deployed in the one or more wireless devices 130.

Details for the third message are specified in the examples for the second network node.

### Action 802

In this Action 802, the wireless device 130 may optionally send the fourth message.

The sending of the fourth message may be to the second network node 112, e.g., via the respective third link 143.

The fourth message may indicate the acknowledgement, failure or a reject of the received third message. That is, the wireless device 130 may send to the second network node 112 the fourth message, to indicate an acknowledgement or failure/reject in response to the third message.

### Action 803

In this Action 803, wireless device 130 sends the additional message.

The sending of the additional message may be to one of the second network node 112 and the first network node 111 operating in the wireless communications network 100.

The sending in this Action 803 may be performed, e.g., via the respective third link 143, and/or the respective first link 141, respectively.

The additional message comprises the one or more reports comprising the information, e.g., the respective information.

In some embodiments, the one or more reports may comprise at least one of: a) a/the testing report of at least one of the one or more ML models, b) a/the verification report of at least one of the one or more ML models, c) a/the validation report of at least one of the one or more ML models, d) a/the evaluation report of at least one of the one or more ML models, e) a/the security assessment report of at least one of the one or more ML models, and f) a/the report of training, updating, or modifying at least one of the one or more ML models.

The respective information may be to enable the first network node 111 to perform the one or more actions. The one or more actions may comprise at least one of: a) retraining or triggering a/the retraining of at least one of the one or more ML models, b) updating or triggering a/the update of at least one of the one or more ML models, c) deploying or triggering a/the deployment of the additional ML model, d) revoking or triggering a/the revocation of at least one of the one or more ML models, e) forwarding the one or more reports to the third network node 113 operating in the wireless communications network 100, and f) completing a/the ongoing procedure handled by the first network node 111.

The ongoing procedure may be one of: the handover execution, the handover preparation, the UE context modification, the UE context setup, the intra-RAT mobility, the inter-RAT mobility, the inter-system mobility, the RRC connection establishment, the RRC connection resume, the RRC reconfiguration, the RRC connection re-establishment, the retrieve UE context, the initial UE context setup, the bearer context setup, the bearer context modification, and the multi-connectivity procedure.

The additional message may comprise at least one of: a) the one or more first indications of the respective identifier or identity of the one or more ML models, b) the one or more second indications of the respective vendor of the one or more ML models, c) the one or more third indications of the respective version of the one or more ML models, d) the one or more fourth indications of the type of the one or more ML models, e) the one or more fifth indications of the respective Operating System of the wireless device 130, f) the one or more sixth indications of the respective identifier of the one or more applications the one or more ML models relate to, g) the one or more seventh indications of the respective identifier of the one or more use cases the one or more ML models relate to, h) the one or more eighth indications of the respective identifier of the one or more services or service types the one or more ML models may relate to, i) the one or more ninth indications of the respective identifier of the one or more network slices the one or more ML models may relate to, j) the cause value indicating the reason for the failure/reject, and k) the one or more data samples associated to one or more LCM operations for the one or more ML models available at least in part in at least one of the one or more wireless devices 130 of: i) testing of the one or more ML models, ii) validation of the one or more ML models, iii) verification of the one or more ML models, iv) evaluation of the one or more ML models, v) security assessment of the one or more ML models, and vi) training of the one or more ML models.

In some examples, the message may be one or the second message and the fifth message. In some of these examples, Action 802 may be performed.

In one variant of embodiments herein, where report(s) comprising LCM information for AI/ML model(s) deployed in the one or more wireless devices 130 may be sent from the second network node 112 to the first network node 111, the one or more wireless devices 130 may send to the second network node 112 the fifth message, comprising report(s) comprising LCM information for AI/ML model(s) deployed in the one or more wireless devices 130.

In another variant of embodiments herein, where report(s) comprising LCM information for AI/ML model(s) deployed in the one or more wireless devices 130 may be sent from the one or more wireless devices 130 to the first network node 111, the one or more wireless devices 130 may send to the first network node 111 the second message, comprising report(s) comprising LCM information for AI/ML model(s) deployed in the one or more wireless devices 130.

In some examples, one of the following may apply: a) the first network node 111 may be the gNB-CU-CP and the second network node 112 may be the gNB-DU, b) the first network node 111 may be the target node and the second network node 112 may be the source node, c) the first network node 111 may be the new node of a Retrieve UE Context procedure and the second network node 112 may be the old node of a Retrieve UE Context procedure, d) the first network node 111 may provide connectivity to the first RAT, and the second network node 112 may provide connectivity to the second RAT, and e) the first network node 111 and the second network node 112 may be involved in the multi-connectivity operation.

In some examples, the additional message may be the second message sent to the first network node 111. The second message may be one of: i) the RRCReconfigurationComplete message, ii) the XnAP ACCESS AND MOBILITY INFORMATION, iii) the XnAP HANDOVER REPORT, iv) the XnAP RRC TRANSFER, v) the XnAP HANDOVER REQUEST, vi) the NGAP HANDOVER REQUEST, vii) the NGAP HANDOVER REQUIRED, viii) the F1AP UL RRC MESSAGE TRANSFER, ix) the F1AP UE CONTEXT SETUP RESPONSE, x) the F1AP UE CONTEXT MODIFICATION RESPONSE, xi) the F1AP UE CONTEXT MODIFICATION REQUIRED, xii) the F1AP UE CONTEXT MODIFICATION CONFIRM, xiii) the F1AP UE CONTEXT SETUP REQUEST, xiv) the F1AP UE CONTEXT MODIFICATION REQUEST, XV) the E1AP BEARER CONTEXT SETUP REQUEST, xvi) the E1AP BEARER CONTEXT MODIFICATION REQUEST, xvii) the E1AP BEARER CONTEXT MODIFICATION REQUIRED, xviii) the E1AP BEARER CONTEXT MODIFICATION CONFIRM, xix) the E1AP BEARER CONTEXT SETUP RESPONSE, xx) the E1AP BEARER CONTEXT MODIFICATION RESPONSE, xxi) the RRC message, xxii) the second new message, and xxiii) any of the preceding messages listed in i-xxii for the second message, comprising the second IE indicating the one or more reports.

Examples of these actions, messages and the indications are provided later in this document.

FIG. 9 is a schematic representation depicting a high-level overview of a non-limiting example of a method performed in a wireless communications network 100, according to embodiments herein, for the case where report(s) comprising LCM information for AI/ML model(s) deployed in the wireless device 130 may be requested by the first network node 111 and sent from the second network node 112 to the first network node 111. The second network node 111 may request reports to the wireless devices 130 after receiving the request from the first network node 111. As depicted in FIG. 9, at 230, the first network node 111, in agreement with Action 601, may receive the another message from the second network node 112 indicating the existence of the one or more ML models available at least in part in the at least one of the one or more wireless devices 130. At 100, the first network node 111 may determine, in accordance with Action 602, the need for LCM information for AI/ML model(s) residing in the one or more wireless devices 130. In one variant of embodiments herein, as depicted in FIG. 9, at 200, the first network node 111 may, according to Action 603 and Action 702, send to the second network node 112 the first message comprising a request, e.g., a subscription request, to obtain report(s) comprising LCM information for AI/ML model(s) deployed at the one or more wireless devices 130, and, at 210, the first network node 111 may, according to Action 604 and Action 708, receive from the second network node 112 the second message comprising report(s) comprising LCM information for AI/ML model(s) deployed at the one or more wireless devices 130 already available at the second network node 112 or indication(s) of failure(s). In another variant of embodiments herein, as depicted in FIG. 9, at 200, the first network node 111 may, according to Action 603 and Action 702, send to the second network node 112 the first message comprising a request, e.g., a subscription request, to obtain report(s) comprising LCM information for AI/ML model(s) deployed at the one or more wireless devices 130 and, at 400, the second network node 112 may, according to Action 704 and Action 801, send to the wireless device 130, or a group of wireless devices 130, the third message comprising a subsequent request, based on the request comprised in the first message, or forwarding the request received in the first message, to obtain from the one or more wireless devices 130 report(s) comprising LCM information for AI/ML model(s) deployed at the one or more wireless devices 130, and, at 420, the second network node 112 may, according to Action 706 and Action 803, receive the fifth message(s) comprising the requested report(s) from the one or more wireless devices 130 and, at 210, the second network node 112 may, according to Action 708 and Action 604, send second message(s) to the first network node 111 comprising the obtained report(s) or indication(s) of failures. As also depicted in FIG. 9, after receiving the first message from the first network node 111, at 300, the second network node 112 may, in accordance with Action 703, determine one of: 1) request the one or more wireless devices 130 for reports comprising LCM information for AI/ML model(s) residing in the one or more wireless devices 130, and 2) forward a request for reports comprising LCM information to the one or more wireless devices 130. In some embodiments, at 410, the second network node 112 may, in accordance with Action 705 and Action 802, receive the fourth message from the wireless device 130 with an acknowledgement or a failure. In some embodiments, at 310, the second network node 112 may, in accordance with Action 707, determine to send/forward available report(s) comprising LCM information for AI/ML model(s) residing in the one or more wireless devices 130. Finally, at 110, the first network node 111 may, in accordance with Action 706, after receiving the second message, determine to use report(s) comprising LCM information of AI/ML model(s) residing in the one or more wireless devices 130.

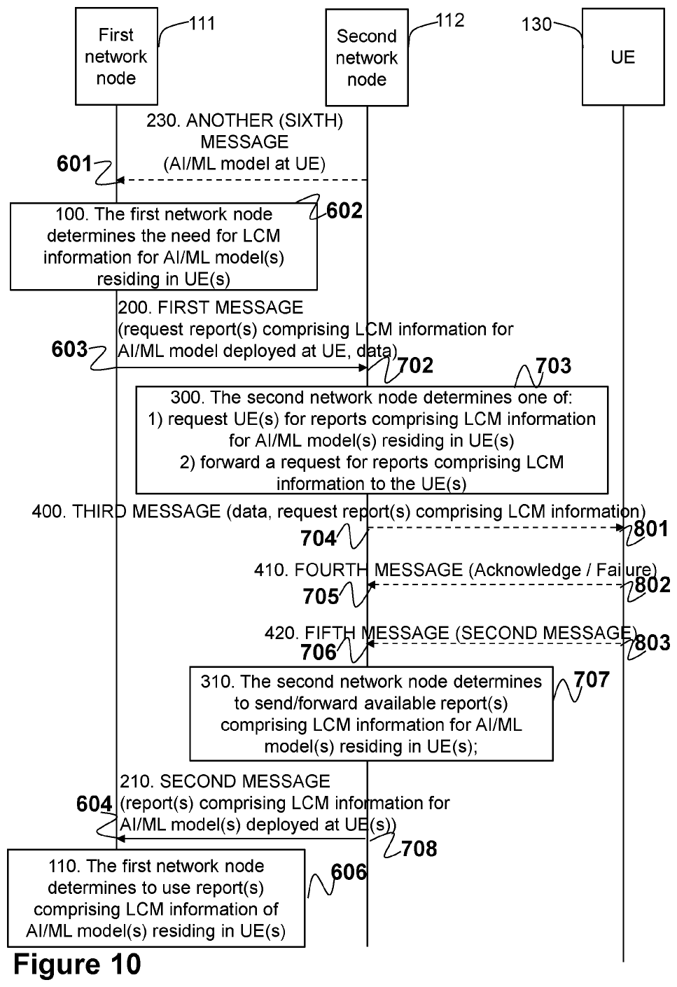

The next FIGS. 10-14 depict some of the steps already described in FIG. 9. The description corresponding to these repeated steps will not be repeated.

FIG. 10 is a schematic representation depicting another non-limiting example of a method performed in a wireless communications network 100, according to embodiments herein. In FIG. 10, a high-level overview of the approach is shown for the case where report(s) comprising LCM information for AI/ML model(s) deployed in the wireless device 130 may be requested by the first network node 111, and the second network node 112 may relay/forward the reports received from the wireless device 130 to the first network node 111. In another variant of embodiments herein, as depicted in FIG. 10, the first network node 111 may, according to Action 603 and Action 702, send to the second network node 112 the first message comprising a request, e.g., a subscription request, to obtain report(s) comprising LCM information for AI/ML model(s) deployed at the one or more wireless devices 130, and the second network node 112, according to Action 704 and Action 801, may send to the wireless device 130 or a group of wireless devices 130 the third message comprising a subsequent request, based on the request comprised in the first message, or forwarding the request received from the first network node 111, to obtain from the one or more wireless devices 130 reports comprising LCM information for AI/ML model(s) deployed at the one or more wireless devices 130, and the one or more wireless devices 130 may, according to Action 803 and Action 706, send(s) to the second network node 112 the fifth message comprising the second message comprising the requested report(s) or indication(s) of failure(s), and the second network node 112 may, according to Action 708 and Action 604, relay/forward the second message to the first network node 111.

FIG. 11 is a schematic representation depicting a further non-limiting example of a method performed in a wireless communications network 100, according to embodiments herein. In FIG. 11, a high-level overview of the solution is shown for the case where report(s) comprising LCM information for AI/ML model(s) deployed in the wireless device 130 may be requested by the first network node 111 and sent from the wireless devices 130 to the first network node 111. In another variant of embodiments herein, as depicted in FIG. 11, the first network node 111 may, according to Action 603 and Action 702, send to the second network node 112 the first message comprising a request, e.g., a subscription request, to obtain report(s) concerning LCM information for AI/ML model(s) deployed at the one or more wireless devices 130, and the second network node 112 may, according to Action 704 and Action 801, send to the wireless device 130 or a group of wireless devices 130 the third message comprising a subsequent request, based on the request comprised in the first message, or forwarding the request received from the first network node 111, to obtain from the one or more wireless devices 130 reports comprising LCM information for AI/ML model(s) deployed at the one or more wireless devices 130, and the UE(s), according to Action 803 and Action 604, may send(s) the second message to the first network node 111 comprising the requested report(s) or indication(s) of failure(s).

In other variants of embodiments herein, as depicted in FIG. 12, FIG. 13, and FIG. 14, the first network node 111, with or without prior transmitting the first message to the second network node 112, may, according to Action 604 and Action 708, receive from the second network node 112 the second message comprising reports concerning LCM information for AI/ML model(s) deployed at the one or more wireless devices 130, and, prior to sending the second message to the first network node, the second network node, according to Action 704 and Action 801, may have sent to the wireless device 130 or a group of wireless devices 130 the third message comprising a request to obtain from the one or more wireless devices 130 reports concerning LCM information for AI/ML model(s) deployed at the one or more wireless devices 130, and the second network node 112 may have received from the one or more wireless devices 130 the fifth message comprising the said reports, in accordance with Action 706 and 803.

FIG. 12 is a schematic representation depicting an additional non-limiting example of a method performed in a wireless communications network 100, according to embodiments herein. In FIG. 12, a high-level overview of the approach is shown for the case where report(s) comprising LCM information for AI/ML model(s) deployed in the wireless device 130 may be sent by the second network node 112 to the first network node 111, according to Action 604 and Action 708, without an explicit request from the first network node 111. The first network node 111 may, according to Action 605 and Action 709, send the further message to indicate an acknowledge/failure/reject to the second network node 112 before using the report(s)

FIG. 13 is a schematic representation depicting yet another non-limiting example of a method performed in a wireless communications network 100, according to embodiments herein. In FIG. 13, a high-level overview of the approach is shown for the case where report(s) comprising LCM information for AI/ML model(s) deployed in the wireless device 130 may be sent by the second network node 112 to the first network node 111, according to Action 604 and Action 708, without an explicit request from the first network node 111. The first network node 111 may send the further message to indicate an acknowledge/failure/reject to the second network node 112 after using the report(s), according to Action 605 and Action 709.

FIG. 14 is a schematic representation depicting a further non-limiting example of a method. In FIG. 14, a high-level overview of the approach is shown for the case where report(s) comprising LCM information for AI/ML model(s) deployed in the wireless device 130, according to Action 604 and Action 708, may be sent by the second network node 112 to the first network node 111 without an explicit request from the first network node 111. The first network node 111, according to Action 605 and Action 709, may send the further message to indicate an acknowledge/failure/reject to the second network node 112 before using the report(s).

The second network node 112 may request reports to the wireless device 130 before receiving the request from the first network node 111.

In the variants described above, reports comprising LCM information for AI/ML model(s) deployed at the one or more wireless devices 130 may comprise testing reports, verification reports, validation reports, evaluation reports, security assessment reports, e.g., vulnerability assessment, privacy risk assessment.

With “AI/ML model deployed at a UE/the wireless device 130” or “AI/ML model residing in a UE/the wireless device 130”, unless explicitly stated otherwise, it is to be intended that at least an inference function of an AI/ML model may be deployed at the wireless device 130. Presence of other functions of the AI/ML model in the same wireless device 130, e.g., an Actor may be understood to not be precluded.

### Overview of the Embodiments Herein

As a summarized overview of the foregoing, according to embodiments herein, methods may be executed in the first network node 111 and the second network node 112 comprised in a communication network for handling reports comprising life cycle management information for AI/ML model(s) deployed at UE(s), e.g., an individual UE or a group of UEs, which may comprise one or more of the following: a) information related to test activities of AI/ML model(s) deployed at UE(s), wherein the AI/ML model testing activity may be executed by a UE, or group of UEs, or a network node; b) Information related to validation activities of AI/ML model(s) deployed at UE(s), wherein the AI/ML model validation activity may be executed by a UE, or group of UEs, or a network node; c) information related to verification activities of AI/ML model(s) deployed at UE(s), wherein the AI/ML model verification activity may be executed by a UE, or group of UEs, or a network node; d) information related to evaluation activities of AI/ML model(s) deployed at UE, wherein the AI/ML model evaluation activity may be executed by a UE, or group of UEs, or a network node; e) information related to security assessments of AI/ML model(s) deployed at UE(s), wherein the AI/ML model security assessments may be executed by a UE, or group of UEs, or a network node; and f) information related to re-training, updating or modification of AI/ML model(s) deployed at UE(s), wherein the AI/ML model re-training, updating or modification activity may be executed by a UE, or group of UEs, or a network node.

Embodiments herein may be understood to disclose methods that may be executed by the first network node 111, by the second network node 112 and by a UE such as the wireless device 130, for handling report(s) comprising life cycle management information associated to AI/ML model(s) deployed at UE(s), wherein the first network node 111 may request reports concerning LCM information for AI/ML model(s) deployed at UE(s), and may obtain the reports from the second network node 112 or from the UE(s).

### Common Aspects Between Messages

At least part of the content of one or more of the first message, second message, third message, fifth message, sixth message may be opaque to the first network node 111 and/or to the second network node 112. For example, information concerning AI/ML model type, AI/ML vendor, AI/ML version may be sent from the second network node 112 to the wireless device 130 or—vice versa—sent from the wireless device 130 to the second network node 112, according to proprietary format and encapsulated in a container to be interpreted by the third network node 113, e.g., a CN node, an OAM node, an SMO node.

As a summarized overview of the foregoing, embodiments herein may be understood to disclose methods that may be executed by the first network node 111, the second network node 112 and the wireless device 130, for handling report(s) comprising life cycle management (LCM) information associated to AI/ML model(s) deployed at the one or more wireless devices 130.

One or more of the following steps may be performed. In a first step, in agreement with Action 603, the first network node 111 may transmit the first message to the second network node 112, the first message comprising at least a request to receive report(s) comprising life cycle management information associated to AI/ML model(s) deployed in at least the wireless device 130. In a second step, in agreement with Action 604, the first network node may 111 receive the second message from the second network node 112, the second message comprising report(s) comprising life cycle management information associated to AI/ML model(s) deployed in at least the wireless device 130.

Different variants of the approach followed herein have been detailed above.

Certain embodiments disclosed herein may provide one or more of the following technical advantage(s), which may be summarized as follows. Non limiting examples of advantages of enabling network nodes to exchange life cycle management information reports concerning AI/ML models deployed, or to be deployed, at wireless devices 130 may be in scenarios such as follows. A scenario may be that the first inference function of the (first) AI/ML model deployed in the wireless device 130 may operate jointly with a second inference function of a second AI/ML model residing in a network node, such as a first network node 111, or the second network node 112. A second scenario may be that the inference function of the (first) AI/ML model deployed in the wireless device 130 may operate jointly with a different function, e.g., a training function, of the same AI/ML model residing in a network node, such as the first network node 111, or the second network node 112. A third scenario may be that a new, or updated, AI/ML model may be pushed over the air for wireless devices 130 based on certain characteristics, e.g., wireless devices 130 exposing certain radio capabilities, wireless devices 130 using certain applications, wireless devices 130 with certain version of the Operating System.

One particular case wherein it may be understood to be advantageous to enable a network node to exchange life cycle management information reports of test activities concerning AI/ML models deployed, or to be deployed, at the one or more wireless devices 130 may be the case of user mobility. When a user device such as the wireless device 130 may move from the coverage area of a network node such as the second network node 112, to the coverage area of another network node such as the first network node 111, it may be understood to be beneficial for the network node that may receive the wireless device 130 to know whether the AI/ML models deployed at the wireless device 130 may have undergone any LCM operations, as well as the/what LCM operations may have been performed for the AI/ML model, e.g., whether the AI/ML model may have been updated, re-trained, modified, tested, validated, verified, evaluated, secured, etc., the results of such LCM operations, e.g., whether the A/IML model may fulfil certain testing or validation criteria, and which entity may have performed LCM operations, e.g., what LCM operations may have been performed by which network node and what LCM operations may have been performed by the wireless device 130. This information may ensure to enable the network node receiving the wireless device 130, here, the first network node 111, to serve the wireless device 130 in the best way, thereby improving the system performance and the quality of experience of the wireless device 130.

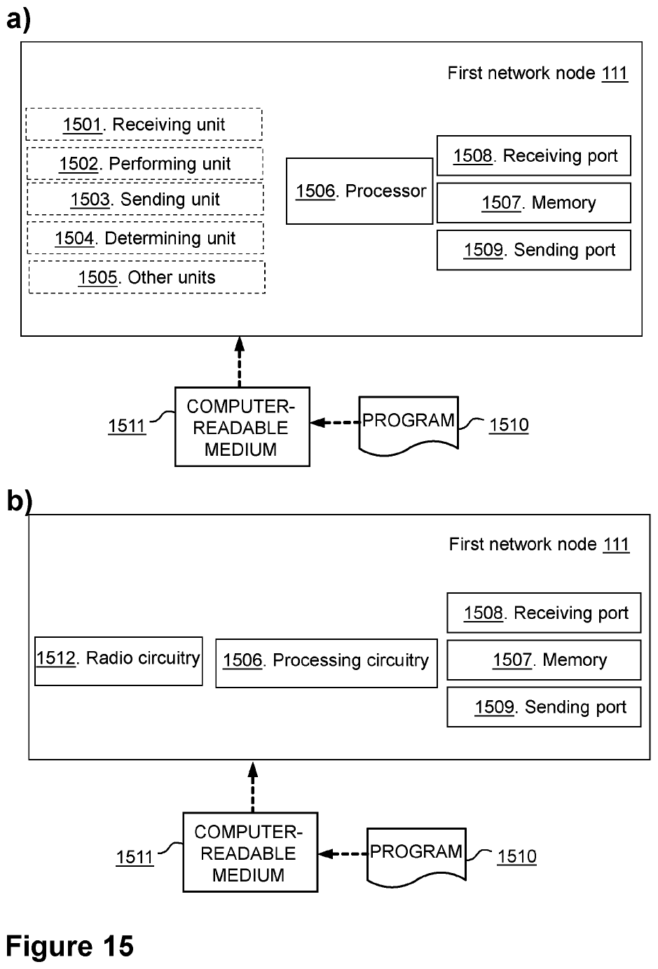

FIG. 15 depicts two different examples in panels a) and b), respectively, of the arrangement that the first network node 111 may comprise. In some embodiments, the first network node 111 may comprise the following arrangement depicted in FIG. 15a. The first network node 111 is configured to operate in the wireless communications network 100. The first network node 111 may be understood to be for handling the one or more reports.

Several embodiments are comprised herein. In some embodiments all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111 and will thus not be repeated here to simplify the description. For example, in some embodiments, the first network node 111 may be configured to be a gNB-CU, the second network node 112 may be configured to be a gNB-DU, and the wireless device 130 may be configured to be a 5G UE.

In FIG. 15, optional units are indicated with dashed boxes.

The first network node 111 is configured to perform the receiving of Action 604, e.g., by means of a receiving unit 1501 within the first network node 111, configured to receive the message, from at least one of the second network node 112 and the one or more wireless devices 130 configured to operate in the wireless communications network 100. The message is configured to comprise the one or more reports configured to comprise the respective information of the respective LCM of the one or more ML models. The one or more ML models are configured to be available at least in part in at least one of the one or more wireless devices 130.

The first network node 111 is also configured to perform the performing in Action 606, e.g., by means of a performing unit 1502 within the first network node 111, configured to perform the one or more actions using the information configured to be comprised in at least one of the one or more reports.

In some embodiments, the one or more reports may be configured to comprise at least one of: a) the testing report of at least one of the one or more ML models, b) the verification report of at least one of the one or more ML models, c) the validation report of at least one of the one or more ML models, d) the evaluation report of at least one of the one or more ML models, e) the security assessment report of at least one of the one or more ML models, and f) the report of training, updating, or modifying at least one of the one or more ML models.

In some embodiments, the one or more actions may be configured to at least one of: a) retraining or triggering a retraining of at least one of the one or more ML models, b) updating or triggering an update of at least one of the one or more ML models, c) deploying or triggering the deployment of the additional ML model, d) revoking or triggering the revocation of at least one of the one or more ML models, e) forwarding the one or more reports to the third network node 113 configured to operate in the wireless communications network 100, and f) completing the ongoing procedure handled by the first network node 111.

The message may be configured to comprise at least one of: a) the one or more first indications of the respective identifier or identity of the one or more ML models, b) the one or more second indications of the respective vendor of the one or more ML models, c) the one or more third indications of the respective version of the one or more ML models, d) the one or more fourth indications of the type of the one or more ML models, e) the one or more fifth indications of the respective Operating System of the one or more wireless devices 130, f) the one or more sixth indications of the respective identifier of the one or more applications the one or more ML models may be configured to relate to, g) the one or more seventh indications of the respective identifier of the one or more use cases the one or more ML models may be configured to relate to, h) the one or more eighth indications of the respective identifier of the one or more services or service types the one or more ML models may be configured to relate to, i) the one or more ninth indications of the respective identifier of one or more network slices the one or more ML models may be configured to relate to, j) the cause value configured to indicate the reason for a failure/reject, and k) the one or more data samples configured to be associated to the one or more LCM operations for the one or more ML models configured to be available at least in part in at least one of the one or more wireless devices 130 of: i) testing of the one or more ML models, ii) validation of the one or more ML models, iii) verification of the one or more ML models, iv) evaluation of the one or more ML models, v) security assessment of the one or more ML models, and vi) training of the one or more ML models.

In some embodiments, wherein the message may be configured to be the second message, the first network node 111 may be further configured to perform the sending of Action 603, e.g., by means of a sending unit 1503 within the first network node 111, configured to send the first message to the second network node 112. The first message may be configured to comprise the first request to receive the one or more reports configured to comprise the respective information of the respective LCM of the one or more ML models configured to be available at least in part in at least one of the one or more wireless devices 130. The second message may be configured to be received in response to the sent first message. The second message may be configured to comprise the one or more reports configured to be requested by the first network node 111.

In some embodiments, wherein the message may be configured to be the second message, the first network node 111 may be further configured to perform the sending in Action 605, e.g. by means of the sending unit 1503, configured to send, in response to the second message configured to be received, the further message to the one of the second network node 112 and the one or more wireless devices 130. The further message may be configured to comprise at least one of: i) the tenth indication, implicit or explicit, of success, ii) the eleventh indication, implicit or explicit, of failure or reject, and iii) the twelfth indication of no support.

In some embodiments, the first message may be further configured to comprise at least one of: a) at least one of the first request and the set of configuration parameters to be sent from the second network node 112 to the one or more wireless devices 130 to obtain the one or more reports, b) the one or more thirteenth indications of the respective one or more of model, vendor and type of the one or more wireless devices 130, c) the one or more fourteenth indications of the respective identity of the one or more wireless devices 130, d) the one or more fifteenth indications of the respective criteria to select the one or more wireless devices 130, e) the sixteenth indication of the area of scope, f) the second request to obtain, from the second network node 112 or from the at least one of the one or more wireless devices 130, the one or more data samples associated to one or more LCM operations for the one or more ML models, of at least one of the one or more wireless devices 130, of: i) testing of the one or more ML models, ii) validation of the one or more ML models, iii) verification of the one or more ML models, iv) evaluation of the one or more ML models, v) security assessment of the one or more ML models, and vi) training of the one or more ML models, g) the seventeenth indication configured to indicate to one of: start, stop, pause, resume, allow and prohibit sending any or all of the one or more reports, h) the eighteenth indication configured to indicate to one of: start, stop, pause, resume, allow and prohibit requesting the additional one or more reports configured to comprise the respective information of the respective LCM of one or more ML models, to at least one of the one or more wireless devices 130, i) the nineteenth indication configured to indicate to the second network node 112 to obtain the latest test report available for at least one of the one or more wireless devices 130, without requesting further test reports from the at least one of the one or more wireless devices 130, j) the one or more conditions on the reporting, and k) the twentieth indication of the reason for requesting the one or more reports.

The first network node 111 may be configured to perform the receiving in Action 601, e.g., by means of the receiving unit 1501, configured to receive, from the second network node 112 or the third network node 113 configured to operate in the wireless communications network 100, the another message. The another message may be configured to indicate the existence of the one or more ML models configured to be available at least in part in the at least one of the one or more wireless devices 130. The first message may be configured to be sent based on the another message configured to be received.

The first network node 111 may be configured to perform the determining in Action 602, e.g., by means of a determining unit 1504 within the first network node 111, configured to determine the need to receive the respective information of the respective LCM of the one or more ML models configured to be available at least in part in the at least one of the one or more wireless devices 130.

Other units 1505 may be comprised in the first network node 111.

The embodiments herein in the first network node 111 may be implemented through one or more processors, such as a processor 1506 in the first network node 111 depicted in FIG. 15a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 1507 comprising one or more memory units. The memory 1507 is arranged to be used to store obtained information, store data, configurations, schedulings, and applications etc. to perform the methods herein when being executed in the first network node 111.

In some embodiments, the first network node 111 may receive information from, e.g., the second network node 112, the third network node 113, the one or more wireless devices 130 and/or another node, through a receiving port 1508. In some embodiments, the receiving port 1508 may be, for example, connected to one or more antennas in first network node 111. In other embodiments, the first network node 111 may receive information from another structure in the wireless communications network 100 through the receiving port 1508. Since the receiving port 1508 may be in communication with the processor 1506, the receiving port 1508 may then send the received information to the processor 1506. The receiving port 1508 may also be configured to receive other information.

The processor 1506 in the first network node 111 may be further configured to transmit or send information to e.g., the second network node 112, the third network node 113, the one or more wireless devices 130, another node, and/or another structure in the wireless communications network 100, through a sending port 1509, which may be in communication with the processor 1506, and the memory 1507.

Those skilled in the art will also appreciate that the units 1501-1505 described above may refer to a combination of analog and digital circuits, and/or one or more processors configured with software and/or firmware, e.g., stored in memory, that, when executed by the one or more processors such as the processor 1506, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1501-1505 described above may be implemented as one or more applications running on one or more processors such as the processor 1506.

Thus, the methods according to the embodiments described herein for the first network node 111 may be respectively implemented by means of a computer program 1510 product, comprising instructions, i.e., software code portions, which, when executed on at least one processor 1506, cause the at least one processor 1506 to carry out the actions described herein, as performed by the first network node 111. The computer program 1510 product may be stored on a computer-readable storage medium 1511. The computer-readable storage medium 1511, having stored thereon the computer program 1510, may comprise instructions which, when executed on at least one processor 1506, cause the at least one processor 1506 to carry out the actions described herein, as performed by the first network node 111. In some embodiments, the computer-readable storage medium 1511 may be a non-transitory computer-readable storage medium, such as a CD ROM disc, or a memory stick. In other embodiments, the computer program 1510 product may be stored on a carrier containing the computer program 1510 just described, wherein the carrier is one of an electronic signal, optical signal, radio signal, or the computer-readable storage medium 1511, as described above.

The first network node 111 may comprise a communication interface configured to facilitate communications between the first network node 111 and other nodes or devices, e.g., the second network node 112, the third network node 113, the one or more wireless devices 130, another node, and/or another structure in the wireless communications network 100. The interface may, for example, include a transceiver configured to transmit and receive radio signals over an air interface in accordance with a suitable standard.

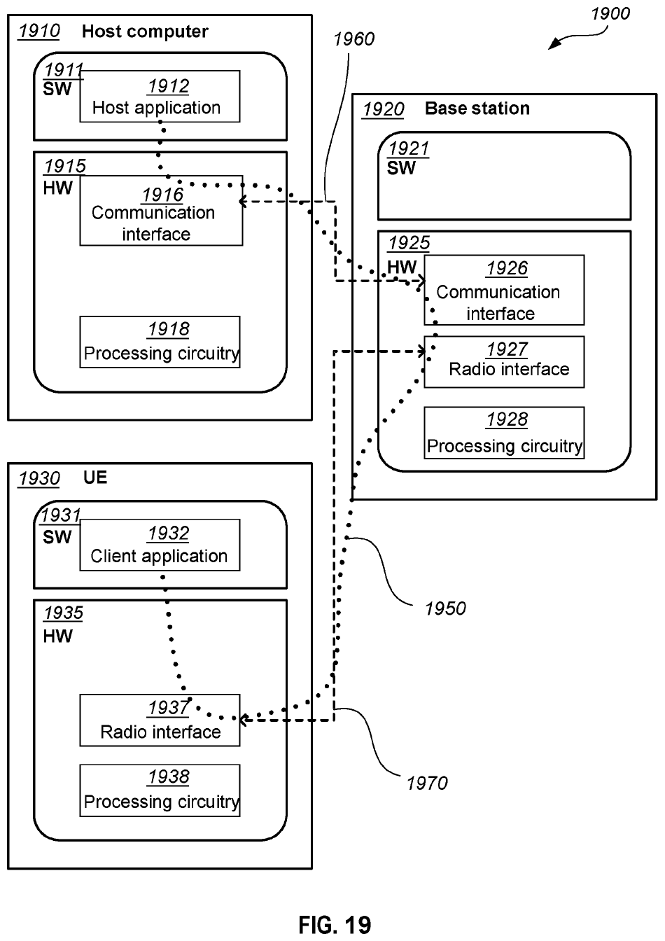

In other embodiments, the first network node 111 may comprise the following arrangement depicted in FIG. 15b. The first network node 111 may comprise a processing circuitry 1506, e.g., one or more processors such as the processor 1506, in the first network node 111 and the memory 1507. The first network node 111 may also comprise a radio circuitry 1512, which may comprise e.g., the receiving port 1508 and the sending port 1509. The processing circuitry 1506 may be configured to, or operable to, perform the method actions according to FIG. 6, FIGS. 9-14, and/or FIGS. 19-23, in a similar manner as that described in relation to FIG. 15a. The radio circuitry 1512 may be configured to set up and maintain at least a wireless connection with the second network node 112, the third network node 113, the one or more wireless devices 130, another node, and/or another structure in the wireless communications network 100. Circuitry may be understood herein as a hardware component.

Hence, embodiments herein also relate to the first network node 111 operative to operate in the wireless communications network 100. The first network node 111 may comprise the processing circuitry 1506 and the memory 1507, said memory 1507 containing instructions executable by said processing circuitry 1506, whereby the first network node 111 is further operative to perform the actions described herein in relation to the first network node 111, e.g., in FIG. 6, FIGS. 9-14 and/or FIGS. 19-23.

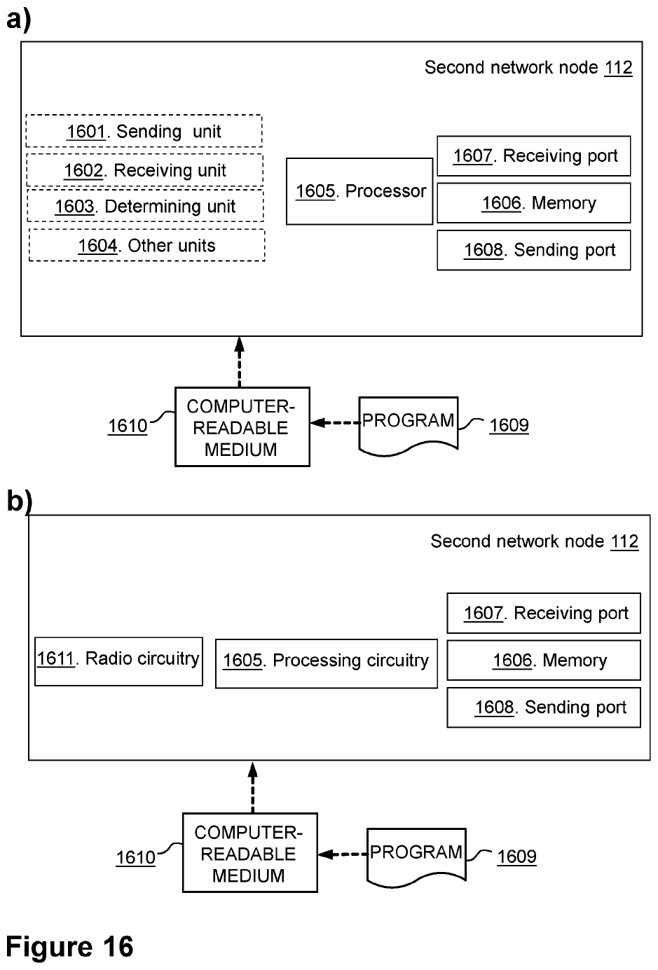

FIG. 16 depicts two different examples in panels a) and b), respectively, of the arrangement that the second network node 112 may comprise. In some embodiments, the second network node 112 may comprise the following arrangement depicted in FIG. 16a. The second network node 112 is configured to operate in the wireless communications network 100. The second network node 112 may be understood to be for handling the one or more reports.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second network node 112 and will thus not be repeated here to simplify the description. For example, in some embodiments, the first network node 111 may be configured to be a gNB-CU, the second network node 112 may be configured to be a gNB-DU, and the wireless device 130 may be configured to be a 5G UE.

In FIG. 16, optional units are indicated with dashed boxes.

The second network node 112 is configured to perform the sending of Action 708, e.g. by means of a sending unit 1601 within the second network node 112, configured to send the message, to the first network node 111 configured to operate in the wireless communications network 100. The message is configured to comprise the one or more reports configured to comprise the respective information, of the respective LCM of the one or more ML models. The one or more ML models may be configured to be available at least in part in at least one of one or more wireless devices 130 configured to operate in the wireless communications network 100.

In some embodiments, the one or more reports may be configured to comprise at least one of: a) the testing report of at least one of the one or more ML models, b) the verification report of at least one of the one or more ML models, c) the validation report of at least one of the one or more ML models, d) the evaluation report of at least one of the one or more ML models, e) the security assessment report of at least one of the one or more ML models, and f) the report of training, updating, or modifying at least one of the one or more ML models.

In some embodiments, wherein the respective information may be configured to enable the first network node 111 to perform the one or more actions, the one or more actions may be configured to comprise at least one of: a) retraining or triggering a retraining of at least one of the one or more ML models, b) updating or triggering the update of at least one of the one or more ML models, c) deploying or triggering the deployment of the additional ML model, d) revoking or triggering the revocation of at least one of the one or more ML models, e) forwarding the one or more reports to the third network node 113 configured to operate in the wireless communications network 100, and f) completing the ongoing procedure handled by the first network node 111.

The message may be configured to comprise at least one of: a) the one or more first indications of the respective identifier or identity of the one or more ML models, b) the one or more second indications of the respective vendor of the one or more ML models, c) the one or more third indications of the respective version of the one or more ML models, d) the one or more fourth indications of the type of the one or more ML models, e) the one or more fifth indications of the respective Operating System of the one or more wireless devices 130, f) the one or more sixth indications of the respective identifier of the one or more applications the one or more ML models may be configured to relate to, g) the one or more seventh indications of the respective identifier of the one or more use cases the one or more ML models may be configured to relate to, h) the one or more eighth indications of the respective identifier of the one or more services or service types the one or more ML models may be configured to relate to, i) the one or more ninth indications of the respective identifier of one or more network slices the one or more ML models may be configured to relate to, j) the cause value configured to indicate the reason for a failure/reject, and k) the one or more data samples configured to be associated to the one or more LCM operations for the one or more ML models configured to be available at least in part in at least one of the one or more wireless devices 130 of: i) testing of the one or more ML models, ii) validation of the one or more ML models, iii) verification of the one or more ML models, iv) evaluation of the one or more ML models, v) security assessment of the one or more ML models, and vi) training of the one or more ML models.

In some embodiments, wherein the message may be configured to be the second message, the second network node 112 may be further configured to perform the receiving of Action 702, e.g. by means of a receiving unit 1602 within the second network node 112, configured to receive the first message from the first network node 111. The first message may be configured to comprise the first request to receive the one or more reports configured to comprise the respective information of the respective LCM of the one or more ML models available at least in part in at least one of the one or more wireless devices 130. The second message may be configured to be sent in response to the first message configured to be received. The second message may be configured to comprise the one or more reports configured to be requested by the first network node 111.

In some embodiments, wherein the message may be configured to be the second message, the second network node 112 may be further configured to perform the determining in Action 703, e.g. by means of a determining unit 1603 within the second network node 112, configured to determine whether or not one of: i) to request the one or more reports from the one or more wireless devices 130, and ii) to forward the request configured to be comprised in the first message configured to be received to the one or more wireless devices 130.

In some embodiments, wherein the message may be configured to be the second message, the second network node 112 may be further configured to perform the sending of Action 704, e.g. by means of the sending unit 1601 within the second network node 112, configured to send the third message, respectively, to the one or more wireless devices 130. The third message may be configured to one of: i) comprise, indicate or forward the first request comprised in the configured to be received first message, and ii) comprise the another request to receive the one or more reports configured to comprise the respective information of the respective LCM of the one or more ML models configured to be available at least in part in at least one of the one or more wireless devices 130. The another request may be configured to be independent of having received or not the first message from the first network node 111.

In some embodiments, wherein the message may be configured to be the second message, the second network node 112 may be further configured to perform the receiving of Action 705, e.g., by means of the receiving unit 1602 within the second network node 112, configured to receive the fourth message, respectively, from the one or more wireless devices 130. The fourth message may be configured to indicate an acknowledgement, failure or a reject of the third message configured to be sent.

In some embodiments, wherein the message may be configured to be the second message, the second network node 112 may be further configured to perform the receiving of Action 706, e.g. by means of the receiving unit 1602 within the second network node 112, configured to receive the fifth message, respectively, from the one or more wireless devices 130. The fifth message may be configured to comprise one of: a) the one or more reports, wherein the second message may be configured to be sent comprising the one or more reports configured to be comprised in the fifth message, and b) the second message, wherein the second network node 112 may be configured to relay the second message configured to be received to the first network node 111.

In some embodiments, wherein the message may be configured to be the second message, the second network node 112 may be further configured to perform the determining in Action 707, e.g. by means of the determining unit 1603 within the second network node 112, configured to determine whether or not to send the one or more reports configured to comprise the respective information of the respective LCM of the one or more ML models configured to be available at least in part in at least one of the one or more wireless devices 130, to the first network node 111.

In some embodiments, wherein the message may be configured to be the second message, the second network node 112 may be further configured to perform the receiving of Action 709, e.g. by means of the receiving unit 1602 within the second network node 112, configured to receive, in response to the second message configured to be sent, the further message from the first network node 111. The further message may be configured to comprise at least one of: i) the tenth indication, implicit or explicit, of success, ii) the eleventh indication, implicit or explicit, of failure or reject, and iii) the twelfth indication of no support.

In some embodiments, the first message may be further configured to comprise at least one of: a) at least one of the first request and the set of configuration parameters to be sent from the second network node 112 to the one or more wireless devices 130 to obtain the one or more reports, b) the one or more thirteenth indications of the respective one or more of model, vendor and type of the one or more wireless devices 130, c) the one or more fourteenth indications of the respective identity of the one or more wireless devices 130, d) the one or more fifteenth indications of the respective criteria to select the one or more wireless devices 130, e) the sixteenth indication of the area of scope, f) the second request to obtain, from the second network node 112 or from the at least one of the one or more wireless devices 130, the one or more data samples associated to one or more LCM operations for the one or more ML models, of at least one of the one or more wireless devices 130, of: i) testing of the one or more ML models, ii) validation of the one or more ML models, iii) verification of the one or more ML models, iv) evaluation of the one or more ML models, v) security assessment of the one or more ML models, and vi) training of the one or more ML models, g) the seventeenth indication configured to indicate to one of: start, stop, pause, resume, allow and prohibit sending any or all of the one or more reports, h) the eighteenth indication configured to indicate to one of: start, stop, pause, resume, allow and prohibit requesting the additional one or more reports configured to comprise the respective information of the respective LCM of the one or more ML models, to at least one of the one or more wireless devices 130, i) the nineteenth indication configured to indicate to the second network node 112 to obtain the latest test report available for at least one of the one or more wireless devices 130, without requesting further test reports from the at least one of the one or more wireless devices 130, j) the one or more conditions on the reporting, and k) the twentieth indication of the reason for requesting the one or more reports.

The second network node 112 may be configured to perform the sending in Action 701, e.g., by means of the sending unit 1601, configured to send, to the first network node 111, the another message. The another message may be configured to indicate the existence of the one or more ML models configured to be available at least in part in the at least one of the one or more wireless devices 130. The first message may be configured to be received based on the another message configured to be sent.

Other units 1604 may be comprised in the second network node 112.

The embodiments herein in the second network node 112 may be implemented through one or more processors, such as a processor 1605 in the second network node 112 depicted in FIG. 16a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second network node 112. One such carrier may be in the form of a CD ROM disc. It is however feasible with other data carriers such as a memory stick. The computer program code may furthermore be provided as pure program code on a server and downloaded to the second network node 112.

The second network node 112 may further comprise a memory 1606 comprising one or more memory units. The memory 1606 is arranged to be used to store obtained information, store data, configurations, schedulings, and applications etc. to perform the methods herein when being executed in the second network node 112.

In some embodiments, the second network node 112 may receive information from, e.g., the first network node 111, the third network node 113, any of the wireless devices in the one or more wireless devices 130 and/or another node, through a receiving port 1607. In some embodiments, the receiving port 1607 may be, for example, connected to one or more antennas in second network node 112. In other embodiments, the second network node 112 may receive information from another structure in the wireless communications network 100 through the receiving port 1607. Since the receiving port 1607 may be in communication with the processor 1605, the receiving port 1607 may then send the received information to the processor 1605. The receiving port 1607 may also be configured to receive other information.

The processor 1605 in the second network node 112 may be further configured to transmit or send information to e.g., the first network node 111, the third network node 113, any of the wireless devices in the one or more wireless devices, another node and/or another structure in the wireless communications network 100, through a sending port 1608, which may be in communication with the processor 1605, and the memory 1606.

Those skilled in the art will also appreciate that the units 1601-1604 described above may refer to a combination of analog and digital circuits, and/or one or more processors configured with software and/or firmware, e.g., stored in memory, that, when executed by the one or more processors such as the processor 1605, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1601-1604 described above may be implemented as one or more applications running on one or more processors such as the processor 1605.

Thus, the methods according to the embodiments described herein for the second network node 112 may be respectively implemented by means of a computer program 1609 product, comprising instructions, i.e., software code portions, which, when executed on at least one processor 1605, cause the at least one processor 1605 to carry out the actions described herein, as performed by the second network node 112. The computer program 1609 product may be stored on a computer-readable storage medium 1610. The computer-readable storage medium 1610, having stored thereon the computer program 1609, may comprise instructions which, when executed on at least one processor 1605, cause the at least one processor 1605 to carry out the actions described herein, as performed by the second network node 112. In some embodiments, the computer-readable storage medium 1610 may be a non-transitory computer-readable storage medium, such as a CD ROM disc, or a memory stick. In other embodiments, the computer program 1609 product may be stored on a carrier containing the computer program 1609 just described, wherein the carrier is one of an electronic signal, optical signal, radio signal, or the computer-readable storage medium 1610, as described above.

The second network node 112 may comprise a communication interface configured to facilitate communications between the second network node 112 and other nodes or devices, e.g., the first network node 111, the third network node 113, any of the wireless devices in the one or more wireless devices, another node and/or another structure in the wireless communications network 100. The interface may, for example, include a transceiver configured to transmit and receive radio signals over an air interface in accordance with a suitable standard.

In other embodiments, the second network node 112 may comprise the following arrangement depicted in FIG. 16b. The second network node 112 may comprise a processing circuitry 1605, e.g., one or more processors such as the processor 1605, in the second network node 112 and the memory 1606. The second network node 112 may also comprise a radio circuitry 1611, which may comprise e.g., the receiving port 1607 and the sending port 1608. The processing circuitry 1605 may be configured to, or operable to, perform the method actions according to FIG. 7, FIG. 9-14 and/or FIGS. 19-23, in a similar manner as that described in relation to FIG. 16a. The radio circuitry 1611 may be configured to set up and maintain at least a wireless connection with the first network node 111, the third network node 113, any of the wireless devices in the one or more wireless devices, another node and/or another structure in the wireless communications network 100. Circuitry may be understood herein as a hardware component.

Hence, embodiments herein also relate to the second network node 112 operative to operate in the wireless communications network 100. The second network node 112 may comprise the processing circuitry 1605 and the memory 1606, said memory 1606 containing instructions executable by said processing circuitry 1605, whereby the second network node 112 is further operative to perform the actions described herein in relation to the second network node 112, e.g., in FIG. 7, FIG. 9-14 and/or FIGS. 19-23.

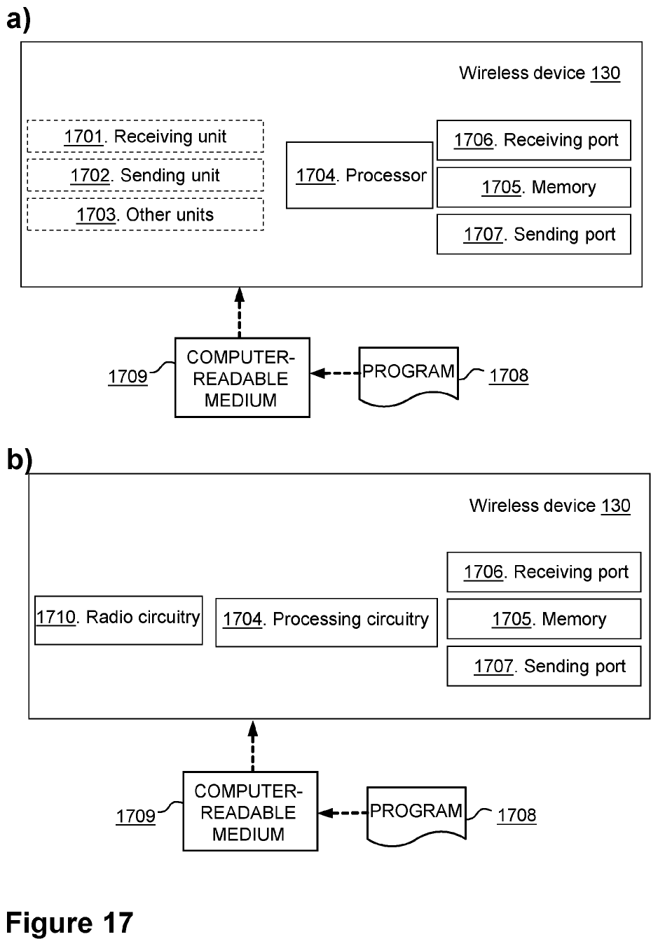

FIG. 17 depicts two different examples in panels a) and b), respectively, of the arrangement that the wireless device 130 may comprise. In some embodiments, the wireless device 130 may comprise the following arrangement depicted in FIG. 17a. The wireless device 130 is configured to operate in the wireless communications network 100. The wireless device 130 may be understood to be for handling the one or more reports.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here to simplify the description. For example, in some embodiments, the first network node 111 may be configured to be a gNB-CU, the second network node 112 may be configured to be a gNB-DU, and the wireless device 130 may be configured to be a 5G UE.

In FIG. 17, optional units are indicated with dashed boxes.

The wireless device 130 may be configured to perform the receiving in Action 801, e.g., by means of a receiving unit 1701 within the wireless device 130, configured to receive the third message from the second network node 112 configured to operate in the wireless communications network 100. The third message is configured to comprise the request to receive the one or more reports configured to comprise the respective information, of the respective LCM of the one or more ML models. The one or more ML models are configured to be available at least in part in the wireless device 130.

The wireless device 130 is also configured to perform the sending in Action 803, e.g., by means of a sending unit 1702 within the wireless device 130, configured to send the additional message, to the one of the second network node 112 and the first network node 111 configured to operate in the wireless communications network 100. The additional message is configured to comprise the one or more reports configured to comprise the respective information.

In some embodiments, the one or more reports may be configured to comprise at least one of: a) the testing report of at least one of the one or more ML models, b) the verification report of at least one of the one or more ML models, c) the validation report of at least one of the one or more ML models, d) the evaluation report of at least one of the one or more ML models, e) the security assessment report of at least one of the one or more ML models, and f) the report of training, updating, or modifying at least one of the one or more ML models.

In some embodiments wherein the respective information may be configured to enable the first network node 111 to perform the one or more actions, the one or more actions may be configured to comprise at least one of: a) retraining or triggering a retraining of at least one of the one or more ML models, b) updating or triggering an update of at least one of the one or more ML models, c) deploying or triggering the deployment of the additional ML model, d) revoking or triggering the revocation of at least one of the one or more ML models, e) forwarding the one or more reports to the third network node 113 configured to operate in the wireless communications network 100, and f) completing the ongoing procedure handled by the first network node 111.

In some embodiments the additional message may be configured to comprise at least one of: a) the one or more first indications of the respective identifier or identity of the one or more ML models, b) the one or more second indications of the respective vendor of the one or more ML models, c) the one or more third indications of the respective version of the one or more ML models, d) the one or more fourth indications of the type of the one or more ML models, e) the one or more fifth indications of the respective Operating System of the one or more wireless devices 130, f) the one or more sixth indications of the respective identifier of the one or more applications the one or more ML models may be configured to relate to, g) the one or more seventh indications of the respective identifier of the one or more use cases the one or more ML models may be configured to relate to, h) the one or more eighth indications of the respective identifier of the one or more services or service types the one or more ML models may be configured to relate to, i) the one or more ninth indications of the respective identifier of one or more network slices the one or more ML models may be configured to relate to, j) the cause value configured to indicate the reason for a failure/reject, and k) the one or more data samples configured to be associated to the one or more LCM operations for the one or more ML models configured to be available at least in part in at least one of the one or more wireless devices 130 of: i) testing of the one or more ML models, ii) validation of the one or more ML models, iii) verification of the one or more ML models, iv) evaluation of the one or more ML models, v) security assessment of the one or more ML models, and vi) training of the one or more ML models.

In some embodiments, wherein the additional message may be configured to be the one or the second message and the fifth message, the wireless device 130 may be configured to perform the sending in this Action 802, e.g., by means of the sending unit 1702, configured to send the fourth message to the second network node 112. The fourth message may be configured to indicate an acknowledgement, failure or a reject of the third message configured to be received.

Other units 1703 may be comprised in the wireless device 130.

The embodiments herein in the wireless device 130 may be implemented through one or more processors, such as a processor 1704 in the wireless device 130 depicted in FIG. 17a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The wireless device 130 may further comprise a memory 1705 comprising one or more memory units. The memory 1705 is arranged to be used to store obtained information, store data, configurations, schedulings, and applications etc. to perform the methods herein when being executed in the wireless device 130.

In some embodiments, the wireless device 130 may receive information from, e.g., the first network node 111, the second network node 112, the third network node 113, any other of the wireless devices in the one or more wireless devices 130 and/or another node, through a receiving port 1706. In some embodiments, the receiving port 1706 may be, for example, connected to one or more antennas in wireless device 130. In other embodiments, the wireless device 130 may receive information from another structure in the wireless communications network 100 through the receiving port 1706. Since the receiving port 1706 may be in communication with the processor 1704, the receiving port 1706 may then send the received information to the processor 1704. The receiving port 1706 may also be configured to receive other information.

The processor 1704 in the wireless device 130 may be further configured to transmit or send information to e.g., the first network node 111, the second network node 112, the third network node 113, any other of the wireless devices in the one or more wireless devices 130, another node and/or another structure in the wireless communications network 100, through a sending port 1707, which may be in communication with the processor 1704, and the memory 1705.

Those skilled in the art will also appreciate that the units 1701-1703 described above may refer to a combination of analog and digital circuits, and/or one or more processors configured with software and/or firmware, e.g., stored in memory, that, when executed by the one or more processors such as the processor 1704, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1701-1703 described above may be implemented as one or more applications running on one or more processors such as the processor 1704.

Thus, the methods according to the embodiments described herein for the wireless device 130 may be respectively implemented by means of a computer program 1708 product, comprising instructions, i.e., software code portions, which, when executed on at least one processor 1704, cause the at least one processor 1704 to carry out the actions described herein, as performed by the wireless device 130. The computer program 1708 product may be stored on a computer-readable storage medium 1709. The computer-readable storage medium 1709, having stored thereon the computer program 1708, may comprise instructions which, when executed on at least one processor 1704, cause the at least one processor 1704 to carry out the actions described herein, as performed by the wireless device 130. In some embodiments, the computer-readable storage medium 1709 may be a non-transitory computer-readable storage medium, such as a CD ROM disc, or a memory stick. In other embodiments, the computer program 1708 product may be stored on a carrier containing the computer program 1708 just described, wherein the carrier is one of an electronic signal, optical signal, radio signal, or the computer-readable storage medium 1709, as described above.

The wireless device 130 may comprise a communication interface configured to facilitate communications between the wireless device 130 and other nodes or devices, e.g., the first network node 111, the second network node 112, the third network node 113, any other of the wireless devices in the one or more wireless devices 130, another node and/or another structure in the wireless communications network 100. The interface may, for example, include a transceiver configured to transmit and receive radio signals over an air interface in accordance with a suitable standard.

In other embodiments, the wireless device 130 may comprise the following arrangement depicted in FIG. 17b. The wireless device 130 may comprise a processing circuitry 1704, e.g., one or more processors such as the processor 1704, in the wireless device 130 and the memory 1705. The wireless device 130 may also comprise a radio circuitry 1710, which may comprise e.g., the receiving port 1706 and the sending port 1707. The processing circuitry 1704 may be configured to, or operable to, perform the method actions according to FIG. 8, FIGS. 9-14 and/or FIGS. 19-23, in a similar manner as that described in relation to FIG. 17a. The radio circuitry 1710 may be configured to set up and maintain at least a wireless connection with the first network node 111, the second network node 112, the third network node 113, any other of the wireless devices in the one or more wireless devices 130, another node and/or another structure in the wireless communications network 100. Circuitry may be understood herein as a hardware component.

Hence, embodiments herein also relate to the wireless device 130 operative to operate in the wireless communications network 100. The wireless device 130 may comprise the processing circuitry 1704 and the memory 1705, said memory 1705 containing instructions executable by said processing circuitry 1704, whereby the wireless device 130 is further operative to perform the actions described herein in relation to the wireless device 130, e.g., in FIG. 8, FIGS. 9-14 and/or FIGS. 19-23.

As used herein, the expression “at least one of: ” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of: ” followed by a list of alternatives separated by commas, and wherein the last alternative is preceded by the “or” term.

When using the word “comprise” or “comprising” it shall be interpreted as non-limiting, i.e. meaning “consist at least of”.

A processor may be understood herein as a hardware component.

The embodiments herein are not limited to the above described preferred embodiments. Various alternatives, modifications and equivalents may be used. Therefore, the above embodiments should not be taken as limiting the scope of the invention.

### Further Extensions And Variations

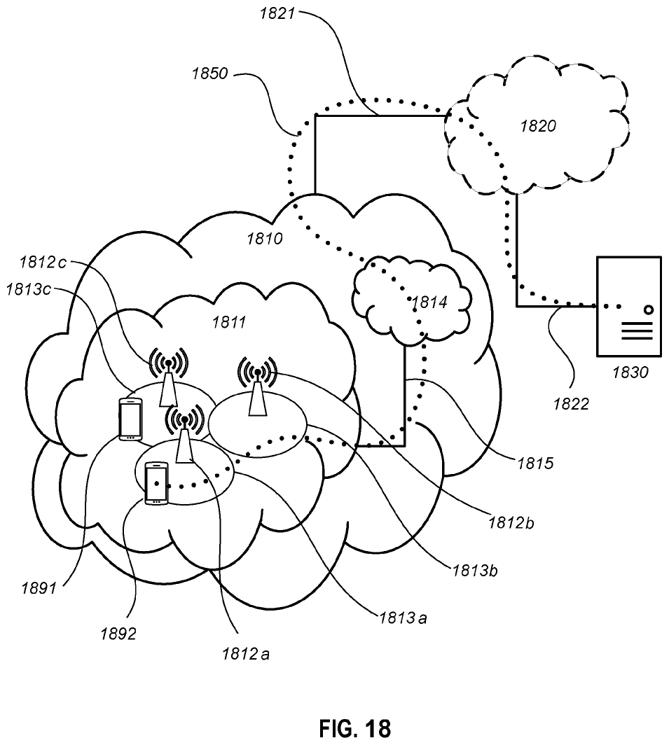

FIG. 18: Telecommunication network connected via an intermediate network to a host computer in accordance with some embodiments

With reference to FIG. 18, in accordance with an embodiment, a communication system includes telecommunication network 1810 such as the wireless communications network 100, for example, a 3GPP-type cellular network, which comprises access network 1811, such as a radio access network, and core network 1814. Access network 1811 comprises a plurality of network nodes such as the first network node 111, the second network node 112 and the third network node 113. For example, base stations 1812a, 1812b, 1812c, such as NBs, eNBs, gNBs or other types of wireless access points, each defining a corresponding coverage area 1813a, 1813b, 1813c. Each base station 1812a, 1812b, 1812c is connectable to core network 1814 over a wired or wireless connection 1815. A plurality of wireless devices, such as the wireless device 130 are comprised in the wireless communications network 100. In FIG. 18, a first UE 1891 located in coverage area 1813c is configured to wirelessly connect to, or be paged by, the corresponding base station 1812c. A second UE 1892 in coverage area 1813a is wirelessly connectable to the corresponding base station 1812a. While a plurality of UEs 1891, 1892 are illustrated in this example, the disclosed embodiments are equally applicable to a situation where a sole UE is in the coverage area or where a sole UE is connecting to the corresponding base station 1812. Any of the UEs 1891, 1892 are examples of the wireless device 130.

Telecommunication network 1810 is itself connected to host computer 1830, which may be embodied in the hardware and/or software of a standalone server, a cloud-implemented server, a distributed server or as processing resources in a server farm. Host computer 1830 may be under the ownership or control of a service provider, or may be operated by the service provider or on behalf of the service provider. Connections 1821 and 1822 between telecommunication network 1810 and host computer 1830 may extend directly from core network 1814 to host computer 1830 or may go via an optional intermediate network 1820. Intermediate network 1820 may be one of, or a combination of more than one of, a public, private or hosted network; intermediate network 1820, if any, may be a backbone network or the Internet; in particular, intermediate network 1820 may comprise two or more sub-networks (not shown).

The communication system of FIG. 18 as a whole enables connectivity between the connected UEs 1891, 1892 and host computer 1830. The connectivity may be described as an over-the-top (OTT) connection 1850. Host computer 1830 and the connected UEs 1891, 1892 are configured to communicate data and/or signaling via OTT connection 1850, using access network 1811, core network 1814, any intermediate network 1820 and possible further infrastructure (not shown) as intermediaries. OTT connection 1850 may be transparent in the sense that the participating communication devices through which OTT connection 1850 passes are unaware of routing of uplink and downlink communications. For example, base station 1812 may not or need not be informed about the past routing of an incoming downlink communication with data originating from host computer 1830 to be forwarded (e.g., handed over) to a connected UE 1891. Similarly, base station 1812 need not be aware of the future routing of an outgoing uplink communication originating from the UE 1891 towards the host computer 1830.

In relation to FIGS. 19, 20, 21, 22, and 23, which are described next, it may be understood that a UE is an example of the wireless device 130, and that any description provided for the UE equally applies to the wireless device 130. It may be also understood that the base station is an example of the first network node 111, the second network node 112 and the third network node 113, and that any description provided for the base station equally applies to the first network node 111, the second network node 112 and the third network node 113.

FIG. 19: Host computer communicating via a base station with a user equipment over a partially wireless connection in accordance with some embodiments

Example implementations, in accordance with an embodiment, of the wireless device 130, e.g., a UE, the first network node 111, the second network node 112 and the third network node 113, e.g., a base station and host computer discussed in the preceding paragraphs will now be described with reference to FIG. 19. In communication system 1900, such as the wireless communications network 100, host computer 1910 comprises hardware 1915 including communication interface 1916 configured to set up and maintain a wired or wireless connection with an interface of a different communication device of communication system 1900. Host computer 1910 further comprises processing circuitry 1918, which may have storage and/or processing capabilities. In particular, processing circuitry 1918 may comprise one or more programmable processors, application-specific integrated circuits, field programmable gate arrays or combinations of these (not shown) adapted to execute instructions. Host computer 1910 further comprises software 1911, which is stored in or accessible by host computer 1910 and executable by processing circuitry 1918. Software 1911 includes host application 1912. Host application 1912 may be operable to provide a service to a remote user, such as UE 1930 connecting via OTT connection 1950 terminating at UE 1930 and host computer 1910. In providing the service to the remote user, host application 1912 may provide user data which is transmitted using OTT connection 1950.

Communication system 1900 further includes the first network node 111, the second network node 112 and the third network node 113, exemplified in FIG. 19 as a base station 1920 provided in a telecommunication system and comprising hardware 1925 enabling it to communicate with host computer 1910 and with UE 1930. Hardware 1925 may include communication interface 1926 for setting up and maintaining a wired or wireless connection with an interface of a different communication device of communication system 1900, as well as radio interface 1927 for setting up and maintaining at least wireless connection 1970 with the wireless device 130, exemplified in FIG. 19 as a UE 1930 located in a coverage area (not shown in FIG. 19) served by base station 1920. Communication interface 1926 may be configured to facilitate connection 1960 to host computer 1910. Connection 1960 may be direct or it may pass through a core network (not shown in FIG. 19) of the telecommunication system and/or through one or more intermediate networks outside the telecommunication system. In the embodiment shown, hardware 1925 of base station 1920 further includes processing circuitry 1928, which may comprise one or more programmable processors, application-specific integrated circuits, field programmable gate arrays or combinations of these (not shown) adapted to execute instructions. Base station 1920 further has software 1921 stored internally or accessible via an external connection.

Communication system 1900 further includes UE 1930 already referred to. Its hardware 1935 may include radio interface 1937 configured to set up and maintain wireless connection 1970 with a base station serving a coverage area in which UE 1930 is currently located. Hardware 1935 of UE 1930 further includes processing circuitry 1938, which may comprise one or more programmable processors, application-specific integrated circuits, field programmable gate arrays or combinations of these (not shown) adapted to execute instructions. UE 1930 further comprises software 1931, which is stored in or accessible by UE 1930 and executable by processing circuitry 1938. Software 1931 includes client application 1932. Client application 1932 may be operable to provide a service to a human or non-human user via UE 1930, with the support of host computer 1910. In host computer 1910, an executing host application 1912 may communicate with the executing client application 1932 via OTT connection 1950 terminating at UE 1930 and host computer 1910. In providing the service to the user, client application 1932 may receive request data from host application 1912 and provide user data in response to the request data. OTT connection 1950 may transfer both the request data and the user data. Client application 1932 may interact with the user to generate the user data that it provides.

It is noted that host computer 1910, base station 1920 and UE 1930 illustrated in FIG. 19 may be similar or identical to host computer 1830, one of base stations 1812a, 1812b, 1812c and one of UEs 1891, 1892 of FIG. 18, respectively. This is to say, the inner workings of these entities may be as shown in FIG. 19 and independently, the surrounding network topology may be that of FIG. 18.

In FIG. 19, OTT connection 1950 has been drawn abstractly to illustrate the communication between host computer 1910 and UE 1930 via base station 1920, without explicit reference to any intermediary devices and the precise routing of messages via these devices. Network infrastructure may determine the routing, which it may be configured to hide from UE 1930 or from the service provider operating host computer 1910, or both. While OTT connection 1950 is active, the network infrastructure may further take decisions by which it dynamically changes the routing (e.g., on the basis of load balancing consideration or reconfiguration of the network).

Wireless connection 1970 between UE 1930 and base station 1920 is in accordance with the teachings of the embodiments described throughout this disclosure. One or more of the various embodiments improve the performance of OTT services provided to UE 1930 using OTT connection 1950, in which wireless connection 1970 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1950 between host computer 1910 and UE 1930, in response to variations in the measurement results. The measurement procedure and/or the network functionality for reconfiguring OTT connection 1950 may be implemented in software 1911 and hardware 1915 of host computer 1910 or in software 1931 and hardware 1935 of UE 1930, or both. In embodiments, sensors (not shown) may be deployed in or in association with communication devices through which OTT connection 1950 passes; the sensors may participate in the measurement procedure by supplying values of the monitored quantities exemplified above, or supplying values of other physical quantities from which software 1911, 1931 may compute or estimate the monitored quantities. The reconfiguring of OTT connection 1950 may include message format, retransmission settings, preferred routing etc.; the reconfiguring need not affect base station 1920, and it may be unknown or imperceptible to base station 1920. Such procedures and functionalities may be known and practiced in the art. In certain embodiments, measurements may involve proprietary UE signaling facilitating host computer 1910's measurements of throughput, propagation times, latency and the like. The measurements may be implemented in that software 1911 and 1931 causes messages to be transmitted, in particular empty or ‘dummy’ messages, using OTT connection 1950 while it monitors propagation times, errors etc.

The first network node 111 embodiments relate to FIG. 6, FIGS. 9-14, FIG. 15 and FIGS. 19-23.

The first network node 111 may comprise an arrangement as shown in FIG. 15 or in FIG. 19.

The first network node 111 may also be configured to communicate user data with a host application unit in a host computer 1910, e.g., via another link such as 1950.

The second network node 112 embodiments relate to FIG. 7, FIGS. 9-14, FIG. 16 and FIGS. 19-23.

The second network node 112 may also be configured to communicate user data with a host application unit in a host computer 1910, e.g., via another link such as 1950.

The second network node 112 may comprise an arrangement as shown in FIG. 16 or in FIG. 19.

The wireless device 130 embodiments relate to FIG. 8, FIGS. 9-14, FIG. 16 and FIGS. 19-23.

The wireless device 130 may also be configured to communicate user data with a host application unit in a host computer 1910, e.g., via another link such as 1950.

The wireless device 130 may comprise an arrangement as shown in FIG. 17 or in FIG. 19.

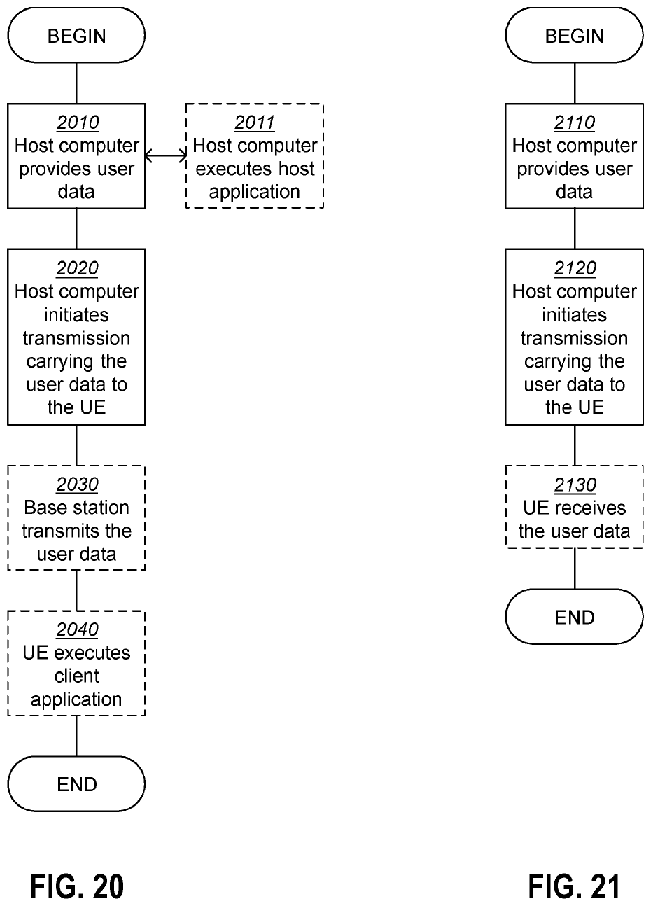

FIG. 20: Methods implemented in a communication system including a host computer, a base station and a user equipment in accordance with some embodiments

FIG. 20 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 20 will be included in this section. In step 2010, the host computer provides user data. In substep 2011 (which may be optional) of step 2010, the host computer provides the user data by executing a host application. In step 2020, the host computer initiates a transmission carrying the user data to the UE. In step 2030 (which may be optional), the base station transmits to the UE the user data which was carried in the transmission that the host computer initiated, in accordance with the teachings of the embodiments described throughout this disclosure. In step 2040 (which may also be optional), the UE executes a client application associated with the host application executed by the host computer.

FIG. 21: Methods implemented in a communication system including a host computer, a base station and a user equipment in accordance with some embodiments

FIG. 21 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 21 will be included in this section. In step 2110 of the method, the host computer provides user data. In an optional substep (not shown) the host computer provides the user data by executing a host application. In step 2120, the host computer initiates a transmission carrying the user data to the UE. The transmission may pass via the base station, in accordance with the teachings of the embodiments described throughout this disclosure. In step 2130 (which may be optional), the UE receives the user data carried in the transmission.

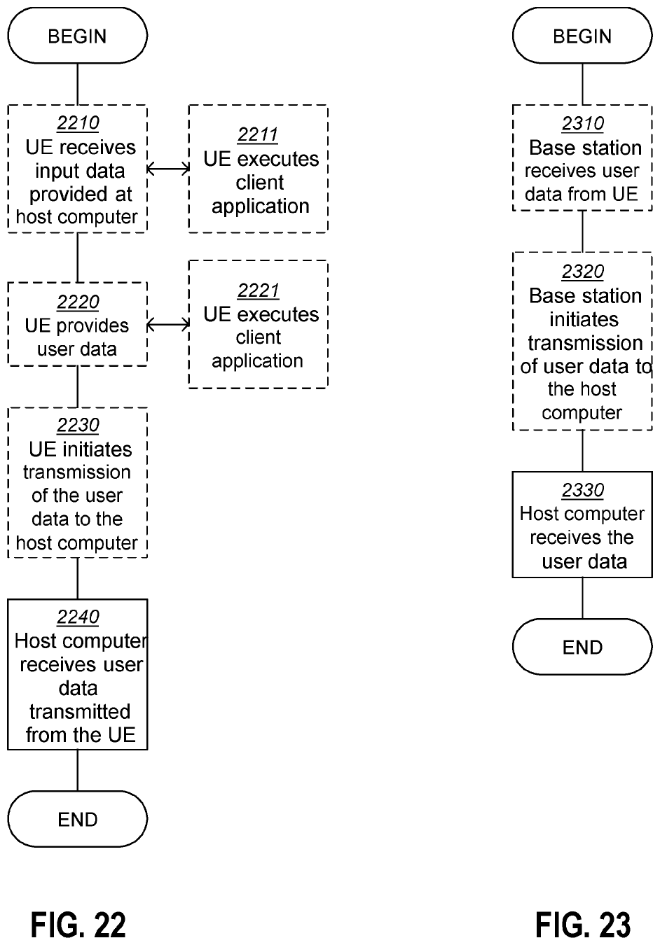

FIG. 22: Methods implemented in a communication system including a host computer, a base station and a user equipment in accordance with some embodiments

FIG. 22 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 22 will be included in this section. In step 2210 (which may be optional), the UE receives input data provided by the host computer. Additionally or alternatively, in step 2220, the UE provides user data. In substep 2221 (which may be optional) of step 2220, the UE provides the user data by executing a client application. In substep 2211 (which may be optional) of step 2210, the UE executes a client application which provides the user data in reaction to the received input data provided by the host computer. In providing the user data, the executed client application may further consider user input received from the user. Regardless of the specific manner in which the user data was provided, the UE initiates, in substep 2230 (which may be optional), transmission of the user data to the host computer. In step 2240 of the method, the host computer receives the user data transmitted from the UE, in accordance with the teachings of the embodiments described throughout this disclosure.

FIG. 23: Methods implemented in a communication system including a host computer, a base station and a user equipment in accordance with some embodiments

FIG. 23 is a flowchart illustrating a method implemented in a communication system, in accordance with one embodiment. The communication system includes a host computer, a base station and a UE which may be those described with reference to FIGS. 18 and 19. For simplicity of the present disclosure, only drawing references to FIG. 23 will be included in this section. In step 2310 (which may be optional), in accordance with the teachings of the embodiments described throughout this disclosure, the base station receives user data from the UE. In step 2320 (which may be optional), the base station initiates transmission of the received user data to the host computer. In step 2330 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the first network node 111, the second network node 112 and the third network node 113.

5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by the first network node 111, the second network node 112 and the third network node 113.

6. The communication system of embodiment 5, further including the base station.

7. The communication system of embodiment 6, further including the UE, wherein the UE is configured to communicate with the base station.

8. The communication system of embodiment 7, wherein:
the processing circuitry of the host computer is configured to execute a host application, thereby providing the user data; and
the UE comprises processing circuitry configured to execute a client application associated with the host application.

11. A method implemented in a base station, comprising one or more of the actions described herein as performed by the first network node 111, the second network node 112 and the third network node 113.

15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by the first network node 111, the second network node 112 and the third network node 113.

16. The method of embodiment 15, further comprising:
at the base station, transmitting the user data.

17. The method of embodiment 16, wherein the user data is provided at the host computer by executing a host application, the method further comprising:
at the UE, executing a client application associated with the host application.

21. A user equipment (UE) configured to communicate with a base station, the UE comprising a radio interface and processing circuitry configured to perform one or more of the actions described herein as performed by the wireless device 130.

25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by the wireless device 130.

26. The communication system of embodiment 25, further including the UE.

27. The communication system of embodiment 26, wherein the cellular network further includes a base station configured to communicate with the UE.

28. The communication system of embodiment 26 or 27, wherein:
the processing circuitry of the host computer is configured to execute a host application, thereby providing the user data; and
the UE's processing circuitry is configured to execute a client application associated with the host application.

31. A method implemented in a user equipment (UE), comprising one or more of the actions described herein as performed by the wireless device 130.

35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by the wireless device 130.

36. The method of embodiment 35, further comprising:
at the UE, receiving the user data from the base station.

41. A user equipment (UE) configured to communicate with a base station, the UE comprising a radio interface and processing circuitry configured to perform one or more of the actions described herein as performed by the wireless device 130.

45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by the wireless device 130.

46. The communication system of embodiment 45, further including the UE.

47. The communication system of embodiment 46, further including the base station, wherein the base station comprises a radio interface configured to communicate with the UE and a communication interface configured to forward to the host computer the user data carried by a transmission from the UE to the base station.

48. The communication system of embodiment 46 or 47, wherein:
the processing circuitry of the host computer is configured to execute a host application; and
the UE's processing circuitry is configured to execute a client application associated with the host application, thereby providing the user data.

49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.

51. A method implemented in a user equipment (UE), comprising one or more of the actions described herein as performed by the wireless device 130.

52. The method of embodiment 51, further comprising:
providing user data; and
forwarding the user data to a host computer via the transmission to the base station.

55. A method implemented in a communication system including a host computer, a base station and a user equipment (UE), the method comprising:
at the host computer, receiving user data transmitted to the base station from the UE, wherein the UE performs one or more of the actions described herein as performed by the wireless device 130.

56. The method of embodiment 55, further comprising:
at the UE, providing the user data to the base station.

57. The method of embodiment 56, further comprising:
at the UE, executing a client application, thereby providing the user data to be transmitted; and
at the host computer, executing a host application associated with the client application.

58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.

61. A base station configured to communicate with a user equipment (UE), the base station comprising a radio interface and processing circuitry configured to perform one or more of the actions described herein as performed by the first network node 111, the second network node 112 and the third network node 113.

65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the first network node 111, the second network node 112 and the third network node 113.

66. The communication system of embodiment 65, further including the base station.

67. The communication system of embodiment 66, further including the UE, wherein the UE is configured to communicate with the base station.

68. The communication system of embodiment 67, wherein:
the processing circuitry of the host computer is configured to execute a host application;
the UE is configured to execute a client application associated with the host application, thereby providing the user data to be received by the host computer.

71. A method implemented in a base station, comprising one or more of the actions described herein as performed by the first network node 111, the second network node 112 and the third network node 113.

75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by the wireless device 130.

76. The method of embodiment 75, further comprising:
at the base station, receiving the user data from the UE.

77. The method of embodiment 76, further comprising:
at the base station, initiating a transmission of the received user data to the host computer.

1-38. (canceled)

39. A method performed by a first network node, the method being for handling one or more reports, the first network node operating in a wireless communications network, and the method comprising:
receiving a message from at least one of a second network node and one or more wireless devices operating in the wireless communications network, the message comprising one or more reports comprising respective information of a respective Life-Cycle Management (LCM) of one or more machine learning (ML) models, the one or more ML models being available at least in part in at least one of the one or more wireless devices; and
performing one or more actions using the information comprised in at least one of the one or more reports.

40. The method of claim 39, wherein the one or more actions comprise at least one of:
retraining or triggering a retraining of at least one of the one or more ML models;
updating or triggering an update of at least one of the one or more ML models;
deploying or triggering a deployment of an additional ML model;
revoking or triggering a revocation of at least one of the one or more ML models;
forwarding the one or more reports to a third network node operating in the wireless communications network; and
completing an ongoing procedure handled by the first network node.

41. The method of claim 39, wherein the message comprises at least one of:
one or more first indications of a respective identifier or identity of the one or more ML models;
one or more second indications of a respective vendor of the one or more ML models;
one or more third indications of a respective version of the one or more ML models;
one or more fourth indications of a type of the one or more ML models;
one or more fifth indications of a respective Operating System of the one or more wireless devices;
one or more sixth indications of a respective identifier of one or more applications the one or more ML models relate to;
one or more seventh indications of a respective identifier of one or more use cases the one or more ML models relate to;
one or more eighth indications of a respective identifier of one or more services or service types the one or more ML models relate to;
one or more ninth indications of a respective identifier of one or more network slices the one or more ML models relate to;
a cause value indicating a reason for a failure/reject; and
one or more data samples associated to one or more LCM operations for the one or more ML models available at least in part in at least one of the one or more wireless devices of:
testing of the one or more ML models;
validation of the one or more ML models;
verification of the one or more ML models;
evaluation of the one or more ML models;
security assessment of the one or more ML models; and
training of the one or more ML models.

42. The method of claim 39, wherein the message is a second message and wherein the method further comprises at least one of:
sending a first message to the second network node, the first message comprising a first request to receive the one or more reports comprising the respective information of the respective LCM of the one or more ML models available at least in part in at least one of the one or more wireless devices, and wherein the second message is received in response to the sent first message, the second message comprising the one or more reports requested by the first network node; and
sending, in response to the received second message, a further message to the one of the second network node and one or more wireless devices, the further message comprising at least one of:
a tenth indication, implicit or explicit, of success;
an eleventh indication, implicit or explicit, of failure or reject; and
a twelfth indication of no support.

43. The method of claim 42, wherein the first message further comprises at least one of:
at least one of a first request and a set of configuration parameters to be sent from the second network node to the one or more wireless devices to obtain the one or more reports;
one or more thirteenth indications of a respective one or more of model, vendor and type of the one or more wireless devices;
one or more fourteenth indications of a respective identity of the one or more wireless devices;
one or more fifteenth indications of respective criteria to select the one or more wireless devices;
a sixteenth indication of an area of scope;
a second request to obtain, from the second network node or from the at least one of the one or more wireless devices, one or more data samples associated to one or more LCM operations for the one or more ML models, of at least one of the one or more wireless devices, of:
testing of the one or more ML models;
validation of the one or more ML models;
verification of the one or more ML models;
evaluation of the one or more ML models;
security assessment of the one or more ML models; and
training of the one or more ML models;
a seventeenth indication indicating to one of: start, stop, pause, resume, allow and prohibit sending any or all of the one or more reports;
an eighteenth indication indicating to one of: start, stop, pause, resume, allow and prohibit requesting additional one or more reports comprising respective information of a respective LCM of one or more ML models, to at least one of the one or more wireless devices;
a nineteenth indication indicating to the second network node to obtain the latest test report available for at least one of the one or more wireless devices, without requesting further test reports from the at least one of the one or more wireless devices;
one or more conditions on the reporting; and
a twentieth indication of a reason for requesting the one or more reports.

44. The method of claim 42, further comprising at least one of:
receiving, from the second network node or a third network node operating in the wireless communications network, another message, the another message indicating the existence of the one or more ML models available at least in part in the at least one of the one or more wireless devices, and wherein the first message is sent based on the received another message; and
determining a need to receive the respective information of the respective LCM of the one or more ML models available at least in part in the at least one of the one or more wireless devices.

45. A method performed by a wireless device, the method being for handling one or more reports, the wireless device operating in a wireless communications network, and the method comprising:
receiving a third message from a second network node operating in the wireless communications network, the third message comprising a request to receive one or more reports comprising respective information of a respective Life-Cycle Management (LCM) of one or more machine learning (ML) models, the one or more ML models being available at least in part in the wireless device; and
sending an additional message, to one of the second network node and a first network node operating in the wireless communications network, the additional message comprising the one or more reports comprising the respective information.

46. The method of claim 45, wherein the one or more reports comprise at least one of:
a testing report of at least one of the one or more ML models;
a verification report of at least one of the one or more ML models;
a validation report of at least one of the one or more ML models;
an evaluation report of at least one of the one or more ML models;
a security assessment report of at least one of the one or more ML models; and
a report of training, updating, or modifying at least one of the one or more ML models.

47. The method of claim 45, wherein the respective information is to enable the first network node to perform one or more actions, the one or more actions comprising at least one of:
retraining or triggering a retraining of at least one of the one or more ML models;
updating or triggering an update of at least one of the one or more ML models;
deploying or triggering a deployment of an additional ML model;
revoking or triggering a revocation of at least one of the one or more ML models;
forwarding the one or more reports to a third network node operating in the wireless communications network; and
completing an ongoing procedure handled by the first network node.

48. The method of claim 45, wherein the additional message comprises at least one of:
one or more first indications of a respective identifier or identity of the one or more ML models;
one or more second indications of a respective vendor of the one or more ML models;
one or more third indications of a respective version of the one or more ML models;
one or more fourth indications of a type of the one or more ML models, one or more fifth indications of a respective Operating System of the wireless device;
one or more sixth indications of a respective identifier of one or more applications the one or more ML models relate to;
one or more seventh indications of a respective identifier of one or more use cases the one or more ML models relate to;
one or more eighth indications of a respective identifier of one or more services or service types the one or more ML models relate to;
one or more ninth indications of a respective identifier of one or more network slices the one or more ML models relate to;
a cause value indicating a reason for a failure/reject; and
one or more data samples associated to one or more LCM operations for the one or more ML models available at least in part in the wireless device of:
testing of the one or more ML models;
validation of the one or more ML models;
verification of the one or more ML models;
evaluation of the one or more ML models;
security assessment of the one or more ML models; and
training of the one or more ML models.

49. The method of claim 45, wherein the additional message is one or a second message and a fifth message and wherein the method further comprises:
sending a fourth message to the second network node, the fourth message indicating an acknowledgment, failure, or a reject of the received third message.

50. A first network node for handling one or more reports, the first network node comprising:
processing circuitry and a memory, the memory containing instructions executable by the processing circuitry whereby the first network node is configured to operate in a wireless communications network, and the first network node being further configured to:
receive a message, from at least one of a second network node and one or more wireless devices configured to operate in the wireless communications network, the message being configured to comprise one or more reports configured to comprise respective information of a respective Life-Cycle Management (LCM) of one or more machine learning (ML) models, the one or more ML models being configured to be available at least in part in at least one of the one or more wireless devices; and
perform one or more actions using the information configured to be comprised in at least one of the one or more reports.

51. The first network node of claim 50, wherein the one or more actions are configured to at least one of:
retraining or triggering a retraining of at least one of the one or more ML models;
updating or triggering an update of at least one of the one or more ML models;
deploying or triggering a deployment of an additional ML model;
revoking or triggering a revocation of at least one of the one or more ML models;
forwarding the one or more reports to a third network node configured to operate in the wireless communications network; and
completing an ongoing procedure handled by the first network node.

52. The first network node of claim 50, wherein the message is configured to comprise at least one of:
one or more first indications of a respective identifier or identity of the one or more ML models;
one or more second indications of a respective vendor of the one or more ML models;
one or more third indications of a respective version of the one or more ML models;
one or more fourth indications of a type of the one or more ML models,
one or more fifth indications of a respective Operating System of the one or more wireless devices;
one or more sixth indications of a respective identifier of one or more applications the one or more ML models are configured to relate to;
one or more seventh indications of a respective identifier of one or more use cases the one or more ML models are configured to relate to;
one or more eighth indications of a respective identifier of one or more services or service types the one or more ML models are configured to relate to;
one or more ninth indications of a respective identifier of one or more network slices the one or more ML models are configured to relate to;
a cause value configured to indicate a reason for a failure/reject; and
one or more data samples configured to be associated to one or more LCM operations for the one or more ML models configured to be available at least in part in at least one of the one or more wireless devices of:
testing of the one or more ML models;
validation of the one or more ML models;
verification of the one or more ML models;
evaluation of the one or more ML models;
security assessment of the one or more ML models; and
training of the one or more ML models.

53. The first network node of claim 50, wherein the message is configured to be a second message and wherein the first network node is further configured to at least one of:
send a first message to the second network node, the first message being configured to comprise a first request to receive the one or more reports configured to comprise the respective information of the respective LCM of the one or more ML models configured to be available at least in part in at least one of the one or more wireless devices, and wherein the second message is configured to be received in response to the sent first message, the second message being configured to comprise the one or more reports configured to be requested by the first network node; and
send, in response to the second message configured to be received, a further message to the one of the second network node and one or more wireless devices, the further message being configured to comprise at least one of:
a tenth indication, implicit or explicit, of success;
an eleventh indication, implicit or explicit, of failure or reject; and
a twelfth indication of no support.

54. The first network node of claim 53, wherein the first message is further configured to comprise at least one of:
at least one of a first request and a set of configuration parameters to be sent from the second network node to the one or more wireless devices to obtain the one or more reports;
one or more thirteenth indications of a respective one or more of model, vendor and type of the one or more wireless devices;
one or more fourteenth indications of a respective identity of the one or more wireless devices;
one or more fifteenth indications of respective criteria to select the one or more wireless devices;
a sixteenth indication of an area of scope;
a second request to obtain, from the second network node or from the at least one of the one or more wireless devices, one or more data samples associated to one or more LCM operations for the one or more ML models, of at least one of the one or more wireless devices, of:
testing of the one or more ML models;
validation of the one or more ML models;
verification of the one or more ML models;
evaluation of the one or more ML models;
security assessment of the one or more ML models; and
training of the one or more ML models;
a seventeenth indication configured to indicate to one of: start, stop, pause, resume, allow and prohibit sending any or all of the one or more reports;
an eighteenth indication configured to indicate to one of: start, stop, pause, resume, allow and prohibit requesting additional one or more reports configured to comprise respective information of a respective LCM of one or more ML models, to at least one of the one or more wireless devices;
a nineteenth indication configured to indicate to the second network node to obtain the latest test report available for at least one of the one or more wireless devices, without requesting further test reports from the at least one of the one or more wireless devices;
one or more conditions on the reporting; and
a twentieth indication of a reason for requesting the one or more reports.

55. The first network node of claim 50, being further configured to at least one of:
receive, from the second network node or a third network node configured to operate in the wireless communications network, another message, the another message being configured to indicate the existence of the one or more ML models configured to be available at least in part in the at least one of the one or more wireless devices, and wherein the first message is configured to be sent based on the another message configured to be received; and
determine a need to receive the respective information of the respective LCM of the one or more ML models configured to be available at least in part in the at least one of the one or more wireless devices.

56. A wireless device for handling one or more reports, the wireless device comprising:
processing circuitry and a memory, the memory containing instructions executable by the processing circuitry whereby the wireless device is configured to operate in a wireless communications network, and the wireless device being further configured to:
receive a third message from a second network node configured to operate in the wireless communications network, the third message being configured to comprise a request to receive one or more reports configured to comprise respective information, of a respective Life-Cycle Management (LCM) of one or more machine learning (ML) models, the one or more ML models being configured to be available at least in part in the wireless device; and
send an additional message, to one of the second network node and a first network node configured to operate in the wireless communications network, the additional message being configured to comprise the one or more reports configured to comprise the respective information.

57. The wireless device of claim 56, wherein the respective information is configured to enable the first network node to perform one or more actions, the one or more actions being configured to comprise at least one of:
retraining or triggering a retraining of at least one of the one or more ML models;
updating or triggering an update of at least one of the one or more ML models;
deploying or triggering a deployment of an additional ML model;
revoking or triggering a revocation of at least one of the one or more ML models;
forwarding the one or more reports to a third network node configured to operate in the wireless communications network; and
completing an ongoing procedure handled by the first network node.

58. The wireless device of claim 56, wherein the additional message is configured to be one or a second message and a fifth message and wherein the wireless device is further configured to:
send a fourth message to the second network node, the fourth message being configured to indicate an acknowledgement, failure or a reject of the third message configured to be received.
